(19) United States
(12) Patent Application Publication
(10) Pub. No.: US 2026/0067366 A1
(43) Pub. Date: Mar. 5, 2026

(54) ON-BOARD DEVICE, PROGRAM, AND INFORMATION PROCESSING METHOD

(71) Applicants: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP); TOYOTA JIDOSHA KABUSHIKI KAISHA, Toyota-shi (JP)

(72) Inventors: Ken FURUTO, Yokkaichi (JP); Hiroshi TATEISHI, Yokkaichi (JP); Tomohiro OTSU, Yokkaichi (JP); Ikuyoshi OTAKE, Kakegawa-shi (JP); Kanade KURIYAMA, Toyota-shi (JP)

(73) Assignees: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP); TOYOTA JIDOSHA KABUSHIKI KAISHA, Toyota-shi (JP)

(21) Appl. No.: 19/305,065

(22) Filed: Aug. 20, 2025

(30) Foreign Application Priority Data
Sep. 4, 2024 (JP) 2024-152488

(51) Int. Cl. H04L 67/12

(52) U.S. Cl. CPC H04L 67/12

(57) ABSTRACT

An on-board device includes a control unit performing processing relevant to a frame transmitted/received between the on-board ECUs, in which the control unit acquires information relevant to software executed in each of the plurality of on-board ECUs, specifies the frame transmitted/received when the software is executed, on the basis of the acquired information relevant to software, specifies a transmission ECU transmitting the specified frame and a reception ECU receiving the specified frame, acquires definition information of the frame of the transmission ECU, acquires definition information of the frame of the reception ECU, creates a conversion rule of the frame, on the basis of the definition information of the frame of the transmission ECU and the definition information of the frame of the reception ECU, converts the frame from the transmission ECU by using the created conversion rule of the frame, and outputs the converted frame to the reception ECU.

### CROSS-REFERENCE TO RELATED APPLICATIONS

This application claims priority based on Japanese Application No. 2024-152488 filed on Sep. 4, 2024, and incorporates the entire contents herein by reference.

### TECHNICAL FIELD

The present disclosure relates to an on-board device, a program, and an information processing method.

### BACKGROUND

An electronic control unit (ECU) for controlling an on-board device such as a drive control system for engine control or the like, and a body system for air conditioner control or the like is mounted on a vehicle. The ECU includes an arithmetic processing unit such as a MPU, for example, a rewritable non-volatile storage unit such as an EEPROM, and a communication unit for communicating with the other ECU, and reads in and executes a control program stored in the storage unit to control the on-board device. Further, a communication device with a wireless communication function is implemented on the vehicle so that communication with a program provision device connected to a vehicle exterior network is available via the communication device, the control program of the ECU can be downloaded (received) from the program provision device, and the control program of the ECU can be updated (for example, refer to Japanese Patent Application Laid-Open No. 2017-97851).

### SUMMARY

However, the communication device (a relay) of Japanese Patent Application Laid-Open No. 2017-97851 does not consider the fact that in a frame transmitted/received when software is executed in the on-board ECU, a conversion rule of the frame is created on the basis of definition information of the frame of a transmission ECU and definition information of the frame of a reception ECU.

An object of the present disclosure is to provide an on-board device or the like, in which in a frame transmitted/received when software is executed in an on-board ECU, a conversion rule of the frame can be created on the basis of definition information of the frame of a transmission ECU and definition information of the frame of a reception ECU.

An on-board device according to one aspect of the disclosure, connected to a plurality of on-board ECUs mounted on a vehicle such that communication is available, includes a control unit performing processing relevant to a frame transmitted/received between the on-board ECUs, in which the control unit acquires information relevant to software executed in each of the plurality of on-board ECUs, specifies the frame transmitted/received when the software is executed, on the basis of the acquired information relevant to software, specifies a transmission ECU transmitting the specified frame and a reception ECU receiving the specified frame, acquires definition information of the frame of the transmission ECU, acquires definition information of the frame of the reception ECU, creates a conversion rule of the frame, on the basis of the definition information of the frame of the transmission ECU and the definition information of the frame of the reception ECU, converts the frame from the transmission ECU by using the created conversion rule of the frame, and outputs the converted frame to the reception ECU.

According to one aspect of the disclosure, it is possible to provide the on-board device or the like, in which in the frame transmitted/received when the software is executed in the on-board ECU, the conversion rule of the frame is created on the basis of the definition information of the frame of the transmission ECU and the definition information of the frame of the reception ECU.

### BRIEF DESCRIPTION OF DRAWINGS

FIG. 1 is a schematic view illustrating a configuration of an on-board system including an on-board device according to a first embodiment.

FIG. 2 is a block diagram illustrating a physical configuration of the on-board device.

FIG. 3 is a flowchart illustrating (main) processing of a control unit of the on-board device.

FIG. 4 is a flowchart illustrating processing (specifying an updated ECU) of the control unit of the on-board device.

FIG. 5 is an explanatory diagram illustrating respects (an ECU software version list) relevant to software implemented on the on-board ECU.

FIG. 6 is a flowchart illustrating processing (specifying a variation in definition version of frame) of the control unit of the on-board device.

FIG. 7 is an explanatory diagram illustrating respects (ECU communication definition information) relevant to the frame transmitted/received when software is executed in an updated ECU.

FIG. 8 is an explanatory diagram illustrating respects (a vehicle communication definition list) relevant to a combination of the on-board ECUs transmitting/receiving the frame.

FIG. 9 is an explanatory diagram illustrating respects (ECU communication definition information) relevant to the frame transmitted/received when software is executed in an opponent ECU.

FIG. 10 is an explanatory diagram illustrating respects (a frame transmission/reception comparison chart) relevant to similarities and variations of the definition version of the frame.

FIG. 11 is a flowchart illustrating processing (creating a conversion rule) of the control unit of the on-board device.

FIG. 12 is an explanatory diagram illustrating respects (a frame version variation chart) relevant to the frames with different definition versions.

FIG. 13 is an explanatory diagram illustrating respects (frame definition information) relevant to definition information in which communication specification items of the frame are defined.

FIG. 14 is a flowchart illustrating processing (determining whether conversion of an identifier is available) of the control unit of the on-board device.

FIG. 15 is an explanatory diagram illustrating respects (a conversion rule preparation task chart) relevant to determining whether the conversion of the identifier is available.

FIG. 16 is a flowchart illustrating processing (determining whether conversion of a period is available) of the control unit of the on-board device.

FIG. 17 is an explanatory diagram illustrating respects (a conversion rule preparation task chart) relevant to determining whether the conversion of the period is available.

FIG. 18 is a flowchart is a illustrating processing (determining whether conversion of a data length is available) of the control unit of the on-board device.

FIG. 19 is an explanatory diagram illustrating respects (a conversion rule preparation task chart) relevant to determining whether the conversion of the data length is available.

FIG. 20 is a flowchart illustrating processing (determining whether conversion of a signal is available) of the control unit of the on-board device.

FIG. 21 is an explanatory diagram illustrating respects (a conversion rule preparation task chart) relevant to determining whether the conversion of the signal is available.

FIG. 22 is an explanatory diagram illustrating respects (a conversion rule table) relevant to the created conversion rule.

FIG. 23 is a flowchart illustrating processing (relay processing) of the control unit of the on-board device.

### DETAILED DESCRIPTION OF PREFERRED EMBODIMENTS

First, an embodiment of the disclosure will be listed and described. In addition, at least a part of the embodiment described below may be arbitrarily combined.

In a first aspect, an on-board device according to one aspect of the disclosure, connected to a plurality of on-board ECUs mounted on a vehicle such that communication is available, includes a control unit performing processing relevant to a frame transmitted/received between the on-board ECUs, in which the control unit acquires information relevant to software executed in each of the plurality of on-board ECUs, specifies the frame transmitted/received when the software is executed, on the basis of the acquired information relevant to software, specifies a transmission ECU transmitting the specified frame and a reception ECU receiving the specified frame, acquires definition information of the frame of the transmission ECU, acquires definition information of the frame of the reception ECU, creates a conversion rule of the frame, on the basis of the definition information of the frame of the transmission ECU and the definition information of the frame of the reception ECU, converts the frame from the transmission ECU by using the created conversion rule of the frame, and outputs the converted frame to the reception ECU.

In such an aspect, the on-board device may function as a relay device that is connected to the plurality of on-board ECUs mounted on the vehicle such that communication is available, and relays the frame (communication data) transmitted/received between the on-board ECUs. Further, the on-board device may function as a repromaster that is connected to an external server such as an over the air (OTA) server, which is provided outside the vehicle, such that communication is available, and applies an update program (software) acquired from an external server to any on-board ECU among the plurality of on-board ECUs mounted on the vehicle to update the software implemented on the on-board ECU. The control unit of the on-board device, for example, acquires and aggregates the information relevant to software implemented on the individual on-board ECU from all the on-board ECUs mounted on the vehicle at a predetermined timing such as when an IG switch is turned off or on. Further, the control unit of the on-board device specifies one or more frames transmitted and received by the on-board ECU in a case where the software is executed in the on-board ECU. The control unit of the on-board device specifies the on-board ECU (the transmission ECU or the reception ECU) transmitting or receiving the frame, in each of the specified frames. The control unit of the on-board device, for example, in accordance with a frame name for uniquely specifying the type of an individual frame, may specify a vehicle ECU transmitting/receiving a frame with the frame name, with reference to a vehicle communication definition list stored in a storage unit. The control unit of the on-board device acquires the definition information in which communication specification items of the frame are defined from each on-board ECU (the transmission ECU or the reception ECU) transmitting or receiving the frame. Since the control unit of the on-board device creates the conversion rule of the frame, on the basis of the definition information acquired from the transmission ECU and the definition information acquired from the reception ECU, it is possible to efficiently create the conversion rule, and automate processing required for the creation of the conversion rule. That is, the control unit of the on-board device is capable of performing processing relevant to the creation of the conversion rule, on the basis of the communication with the on-board ECU in the vehicle, which can be processing or control completed in the vehicle. Further, the control unit of the on-board device is capable of timely creating the conversion rule when the software of any on-board ECU is updated (the version is upgraded), and flexibly responding to the update of the software. Since the control unit of the on-board device converts the frame from the transmission ECU by using the conversion rule automatically created as described above, and outputs (relays) the frame to the reception ECU, it is possible to establish communication between the transmission ECU and the reception ECU even in a case where compatibility is lost due to a version variation (difference) in the software implemented on the transmission ECU and the reception ECU.

In a second aspect, in the on-board device according to one aspect of the disclosure, the information relevant to software includes a version of the software, and the control unit specifies an updated ECU in which the software is updated, on the basis of the version of the software, in the plurality of on-board ECUs, and specifies the frame transmitted/received when the software implemented on the specified updated ECU is executed.

In such an aspect, the control unit of the on-board device, for example, acquires and aggregates the information relevant to software, such as the model (the software part number) or the version of the software implemented on the individual on-board ECU, from all the on-board ECUs mounted on the vehicle when the IG switch is turned off. The control unit of the on-board device may store information relevant to software aggregated from each of the on-board ECUs in the storage unit of the on-board device, for example, in a table format (an ECU software version list). In addition, the control unit of the on-board device, for example, communicates with each of the on-board ECUs described (registered) in ECU software version list when the IG switch is turned on, and acquires and aggregates the information relevant to software from each of the on-board ECUs. As described above, the control unit of the on-board device is capable of specifying the on-board ECU in which the version of the software is updated by comparing the previously aggregated information relevant to software with the currently aggregated information relevant to software. That is, in a case where the on-board ECU is replaced, or the software implemented on the on-board ECU is rewritten or the version is upgraded, before the IG switch is currently turned on after the IG switch is previously turned off, it is possible to specify the on-board ECU (the updated ECU) in which the version of the software is updated by extracting a difference between the previously aggregated information relevant to software and the currently aggregated information relevant to software. In addition, since the control unit of the on-board device specifies the frame transmitted/received when the specified software implemented on the updated ECU is executed, it is possible to efficiently specify the frame affected by the version upgrade of the software, and efficiently create the conversion rule corresponding only to the frame (the frame affected by the version upgrade of the software).

In a third aspect, in the on-board device according to one aspect of the disclosure, the information relevant to software includes the version of the frame transmitted/received when the software is executed, and the control unit creates the conversion rule of the frame when the version of the frame of the transmission ECU is different from the version of the frame of the reception ECU.

In such an aspect, the information relevant to software, acquired from the individual on-board ECU, includes the version of one or more frames transmitted/received when the software is executed in the on-board ECU. That is, by executing the software implemented on the on-board ECU, the on-board ECU performs processing of creating and transmitting the any type of frame (the frame name), and receiving the other type of frame (the frame name). In this case, the transmitted/received frames are defined by the frame name, the version (a definition version), and a transmission/reception flag (1: transmission, 0: reception), and in the case of reception, a conversion allowance may be given. In a case where the versions of the frames are different in each of the on-board ECUs (the transmission ECU and the reception ECU) transmitting/receiving the frames with the same frame name, the control unit of the on-board device determines that frame conversion processing is required, and creates the conversion rule of the frame. In a case where the versions of the frames are the same in each of the on-board ECUs (the transmission ECU and the reception ECU) transmitting/receiving the frames with the same frame name, the control unit of the on-board device determines that the frame conversion processing is not required, and does not create the conversion rule of the frame. As described above, in a case where the software implemented on the on-board ECU is updated, it is assumed that there are a plurality of types of frames (frame names) to be a processing target of the software, and the conversion rule is created in the type of individual frame (the frame name), and thus, it is possible to ensure or improve the availability of the conversion rule.

In a fourth aspect, in the on-board device according to one aspect of the disclosure, the definition information of the frame includes a plurality of communication specification items, and the control unit determines whether there is a variation (difference) in each of the communication specification items included in the definition information of the frames of the transmission ECU and the reception ECU, and creates the conversion rule in accordance with the communication specification item with a variation (difference).

In such an aspect, the definition information of the frame transmitted/received when the software is executed in the on-board ECU includes the plurality of communication specification items. The definition information of the frame is different in accordance with the version of the frame, and in this case, it is assumed that there is a variation (difference) only in a part of the communication specification items among the plurality of communication specification items included in the definition information. In a case where the version number of the frame (the frame name) in the transmission ECU is different from the version number of the frame (the frame name) in the reception ECU, in each of the on-board ECUs (the transmission ECU and the reception ECU) transmitting/receiving the same type of frames (the frames with the same frame name), the control unit of the on-board device determines whether there is a variation (difference) in each of the communication specification items included in the definition information of the frames of the transmission ECU and the reception ECU. In addition, the control unit of the on-board device extracts the communication specification item with a variation (difference), and creates the conversion rule in each of one or more extracted communication specification items. Accordingly, the control unit of the on-board device may create the conversion rule by not including the communication specification item without a variation (difference) in the conversion rule or by explicitly including that conversion is not required. As described above, it is possible to efficiently create the conversion rule by including only the communication specification item with a variation (difference) in the conversion rule, in accordance with a version variation (difference) of the frame, in each of the communication specification items included in the definition information of the frame.

In a fifth aspect, in the on-board device according to one aspect of the disclosure, the communication specification item includes an identifier of the frame, and the control unit creates the conversion rule by including that the identifier of the frame of the transmission ECU is converted into the identifier of the frame of the reception ECU when the identifiers of the frames are different in the frames of the transmission ECU and the reception ECU.

In such an aspect, the communication specification item included in the definition information of the frame, for example, includes the identifier of the frame, such as a CANID (a message ID) in a controller area network (CAN) or CANFD. The identifier of the frame is not limited to the CANID (the message ID) in the CAN or the like, and for example, may be a TCP port number or a UDP port number in a case where communication protocol is Ethernet (registered trademark). The control unit of the on-board device creates the conversion rule by including that the identifier (such as CANID) of the frame of the transmission ECU is converted into the identifier (such as CANID) of the frame of the reception ECU in a case where the identifiers (such as CANID) of the frames are different in each of the on-board ECUs (the transmission ECU and the reception ECU) transmitting/receiving the same type of frames (the frames with the same frame name). By creating the conversion rule as described above, even in a case where the identifiers of the frames (the frames with the same frame name) transmitted/received when the software is executed are different between the transmission ECU and the reception ECU due to the influence of the updated software, it is possible to establish communication between the transmission ECU and the reception ECU.

In a sixth aspect, in the on-board device according to one aspect of the disclosure, the communication specification item includes a period of the frame, and the control unit creates the conversion rule by including that the period of the frame of the transmission ECU is converted into the period of the frame of the reception ECU when the period of the frame of the transmission ECU is shorter than the period of the frame of the reception ECU or the reception ECU allows a variation (difference) in the period.

In such an aspect, the communication specification item included in the definition information of the frame includes the period (transmission/reception periods) of the frame. That is, the period of the frame corresponds to the transmission period of the frame of the transmission ECU, and corresponds to the reception period of the frame of the reception ECU. In a case where the periods (the transmission/reception periods) of the frames are different in each of the on-board ECUs (the transmission ECU and the reception ECU) transmitting/receiving the same type of frames (the frames with the same frame name), the control unit of the on-board device creates the conversion rule by including that the period (the transmission period) of the frame of the transmission ECU is converted into the period (the reception period) of the frame of the reception ECU. In this case, the control unit of the on-board device may output (relay) the frame from the transmission ECU to the reception ECU by including the frame in the period (the reception period) of the reception ECU in a case where the period (the transmission period) of the frame of the transmission ECU is shorter than the period (the reception period) of the frame of the reception ECU (Change Allowance: available when there is no information loss). As described above, in a case where the period (the transmission period) of the frame of the transmission ECU is shorter than the period (the reception period) of the frame of the reception ECU, in an information amount processed in unit time, the information amount of the transmission ECU (the transmission side) is larger than the information amount of the reception ECU (the reception side). Accordingly, even in a case where the information amount of the transmission ECU (the transmission side) is reduced to the information amount of the reception ECU (the reception side), update (transmission from the transmission ECU) is more frequently performed than an information update period expected by the reception ECU (the reception side), and thus, there is no loss in the information amount acquired by the reception ECU (the reception side). Alternatively, in a case where the reception ECU allows a variation in the period (Change Allowance: consistently available) even when the period (the transmission period) of the frame of the transmission ECU is not shorter, that is, longer than the period (the reception period) of the frame of the reception ECU, the control unit of the on-board device may output (relay) the frame from the transmission ECU to the reception ECU by including the frame in the period (the reception period) of the reception ECU. By creating the conversion rule as described above, even in a case where the periods (the transmission/reception periods) of the frames (the frames with the same frame name) transmitted/received when the software is executed are different between the transmission ECU and the reception ECU due to the influence of the updated software, it is possible to establish communication between the transmission ECU and the reception ECU.

In a seventh aspect, in the on-board device according to one aspect of the disclosure, the communication specification item includes a data length of the frame, and the control unit creates the conversion rule by including that the data length of the frame of the transmission ECU is converted into the data length of the frame of the reception ECU when the data length of the frame of the transmission ECU is shorter than the data length of the frame of the reception ECU or when the reception ECU allows a variation (difference) in the data length.

In such an aspect, the communication specification item included in the definition information of the frame includes the data length of the frame. The control unit of the on-board device creates the conversion rule by including that the data length of the frame of the transmission ECU is converted into the data length of the frame of the reception ECU in a case where the data lengths of the frames, that is, the data lengths of payloads included in the frames are different in each of the on-board ECUs (the transmission ECU and the reception ECU) transmitting/receiving the same type of frames (the frames with the same frame name). In this case, when the data length of the transmission ECU is longer than the data length of the frame of the reception ECU (Change Allowance: available when there is no information loss), the control unit of the on-board device may output (relay) the data length of the frame from the transmission ECU to the reception ECU by including the data length in the data length of the reception ECU. As described above, in a case where the data length of the frame of the transmission ECU is longer than the data length of the frame of the reception ECU, in the information amount processed in unit time, the information amount of the transmission ECU (the transmission side) is larger than the information amount of the reception ECU (the reception side). Accordingly, even in a case where the information amount of the transmission ECU (the transmission side) is reduced to the information amount of the reception ECU (the reception side), the data length is longer than the data length expected by the reception ECU (the reception side), and thus, there is no loss in the information amount acquired by the reception ECU (the reception side). Alternatively, in a case where the reception ECU allows a variation in the data length (Change Allowance: consistently available) even when the data length of the transmission ECU is not longer, that is, shorter than the data length of the reception ECU, the control unit of the on-board device may output (relay) the frame from the transmission ECU to the reception ECU by including the frame in the data length of the reception ECU. By creating the conversion rule as described above, even in a case where the data lengths of the frames (the frames with the same frame name) transmitted/received when the software is executed are different between the transmission ECU and the reception ECU due to the influence of the updated software, it is possible to establish communication between the transmission ECU and the reception ECU.

In an eighth aspect, in the on-board device according to one aspect of the disclosure, the communication specification item includes resolution of data included in the frame, and the control unit creates the conversion rule by including that the resolution of the frame of the transmission ECU is converted into the resolution of the frame of the reception ECU when the resolution of the frame of the transmission ECU is finer than the resolution of the frame of the reception ECU or the reception ECU allows a variation (difference) in the resolution.

In such an aspect, the communication specification item included in the definition information of the frame includes the resolution of the data (a measured value) included in the frame. The data, for example, is a measured value or the value of a signal, which is measured, detected, or output by various sensors or the like connected to the transmission ECU, and the resolution is a value according to the property or the specification of the sensor. The resolution, for example, is composed of physical unit such as mm or cm, and the value of the resolution indicated by a numerical value according to the physical unit, and may further take an offset value into account. In this case, the value of the signal output from the sensor may be calculated as “Value of Signal=(Physical Value/Resolution)−Offset Value” by subtracting the offset value from a value obtained by dividing the physical value by the value of the resolution. In a case where the resolution of the data stored in the payload of the frame is different in each of the on-board ECUs (the transmission ECU and the reception ECU) transmitting/receiving the same type of frames (the frames with the same frame name), the control unit of the on-board device creates the conversion rule by including that the resolution of the frame of the transmission ECU is converted into the resolution of the frame of the reception ECU. In this case, in a case where the resolution of the transmission ECU is finer than the resolution of the frame of the reception ECU (Change Allowance: available when there is no information loss), the control unit of the on-board device may output (relay) the resolution of the frame from the transmission ECU to the reception ECU by including the resolution in the resolution of the reception ECU. As described above, in a case where the resolution of the frame of the transmission ECU is finer than the resolution of the frame of the reception ECU, in the information amount processed in unit time, the information amount of the transmission ECU (the transmission side) is larger than the information amount of the reception ECU (the reception side). Accordingly, even in a case where the information amount of the transmission ECU (the transmission side) is reduced to the information amount of the reception ECU (the reception side), the resolution is finer than the resolution expected by the reception ECU (the reception side), and thus, there is no loss in the information amount acquired by the reception ECU (the reception side). Alternatively, in a case where the reception ECU allows a variation in the resolution (Change Allowance: consistently available) even when the resolution of the transmission ECU is not finer, that is, rougher than the resolution of the reception ECU, the control unit of the on-board device may output (relay) the frame to the reception ECU by including the frame from the transmission ECU in the resolution of the reception ECU. By creating the conversion rule as described above, even in a case where the resolution of the frames (the frames with the same frame name) transmitted/received when the software is executed is different between the transmission ECU and the reception ECU due to the influence of the updated software, it is possible to establish communication between the transmission ECU and the reception ECU.

In a ninth aspect, in the on-board device according to one aspect of the disclosure, the control unit extracts the communication specification item with a variation (difference) between the transmission ECU and the reception ECU, in the plurality of communication specification items included in the definition information of the frame, determines whether conversion is available in the communication specification item with a variation (difference), and aborts processing of creating the conversion rule when conversion is not available in the communication specification item.

In such an aspect, the control unit of the on-board device extracts a variation in the communication specification item of the frame, in each of the on-board ECUs (the transmission ECU and the reception ECU) transmitting/receiving the same type of frames (the frames with the same frame name). The communication specification item, for example, includes a start position (a start bit number) and an end position (an end bit number) when the identifier, the period, the data length, the resolution, and the data (the value of the individual signal) of the frame are stored. The control unit of the on-board device determines whether the conversion is available in each of one or more extracted communication specification items. In a case where it is determined that conversion is available for all the communication specification items with a variation, the control unit of the on-board device creates the conversion rule. In a case where it is determined that conversion for any communication specification item is not available in the communication specification items with a variation, the control unit of the on-board device aborts processing of creating the conversion rule. In a case where the processing is aborted without creating the conversion rule as described above, the control unit of the on-board device outputs that the on-board ECU (the updated ECU) in which the software is updated is invalid, for example, to a human machine interface (HMI) device such as a display. In this case, the control unit of the on-board device may inform respects relevant to a version change, such as restoring the version of the software of the updated ECU, in addition to the notification indicating that the updated ECU is invalid. It is assumed that the versions (the definition versions) of the frames are different in each of the on-board ECUs (the transmission ECU and the reception ECU) transmitting/receiving the same type of frames (the frames with the same frame name), and thus, there is a variation in one or more communication specification items. In this case, when it is determined that conversion is not available only for any one communication specification item among the communication specification items with a variation, the control unit of the on-board device aborts the processing of creating the conversion rule, and outputs a notification indicating that the updated ECU is invalid. Accordingly, in a case where the conversion rule is created, it is possible to ensure that the created conversion rule corresponds to all the communication specification items with a variation, and in a case where the conversion rule is not created, it is possible to efficiently inform an operator of the vehicle that the on-board ECU (the updated ECU) in which the software updated is invalid.

In a tenth aspect, a program according to one aspect of the disclosure, causing a computer that is connected to a plurality of on-board ECUs mounted on a vehicle such that communication is available and performs processing relevant to a frame transmitted/received between the on-board ECUs to execute processing of: acquiring information relevant to software executed in each of the plurality of on-board ECUs; specifying the frame transmitted/received when the software is executed, on the basis of the acquired information relevant to software; specifying a transmission ECU transmitting the specified frame and a reception ECU receiving the specified frame; acquiring definition information of the frame of the transmission ECU; acquiring definition information of the frame of the reception ECU; creating a conversion rule of the frame, on the basis of the definition information of the frame of the transmission ECU and the definition information of the frame of the reception ECU; converting the frame from the transmission ECU by using the created conversion rule of the frame; and outputting the converted frame to the reception ECU.

In such an aspect, it is possible to provide the program causing the computer to be executed as an on-board device efficiently specifying the ECU when an additional program acquired from an external server is applied to any ECU mounted on the vehicle.

In an eleventh aspect, an information processing method according to one aspect of the disclosure, causing a computer that is connected to a plurality of on-board ECUs mounted on a vehicle such that communication is available and performs processing relevant to a frame transmitted/received between the on-board ECUs to execute processing of: acquiring information relevant to software executed in each of the plurality of on-board ECUs; specifying the frame transmitted/received when the software is executed, on the basis of the acquired information relevant to software; specifying a transmission ECU transmitting the specified frame and a reception ECU receiving the specified frame; acquiring definition information of the frame of the transmission ECU; acquiring definition information of the frame of the reception ECU; creating a conversion rule of the frame, on the basis of the definition information of the frame of the transmission ECU and the definition information of the frame of the reception ECU; converting the frame from the transmission ECU by using the created conversion rule of the frame; and outputting the converted frame to the reception ECU.

In such an aspect, it is possible to provide the information processing method to be executed as an on-board device efficiently specifying the ECU when an additional program acquired from an external server is applied to any ECU mounted on the vehicle.

The disclosure will be described in detail, on the basis of the drawings illustrating the embodiment thereof. An on-board device 2 according to the embodiment of the disclosure will be described below with reference to the drawings. Note that the disclosure is not limited to such examples, but is indicated by the claims, and is intended to include the meaning equivalent to the claims and all modifications within the scope.

### First Embodiment

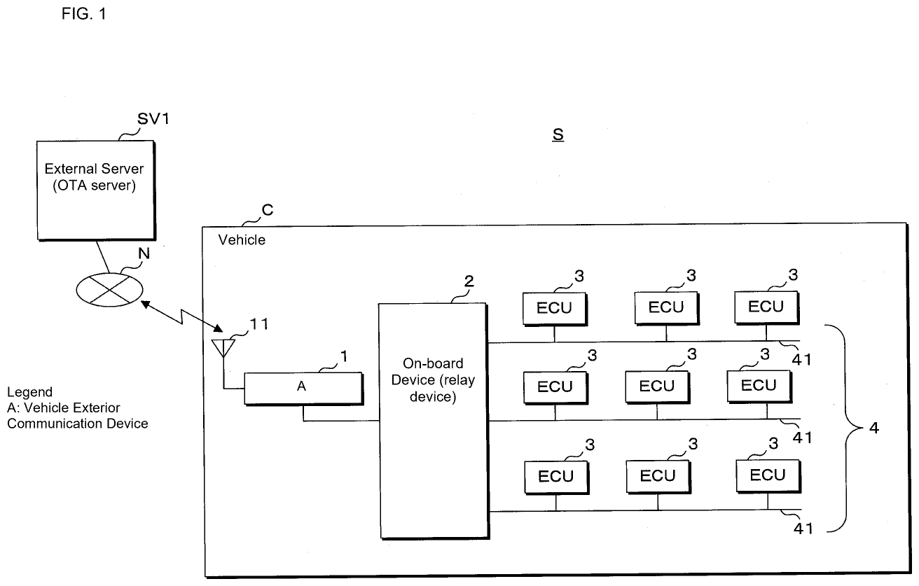

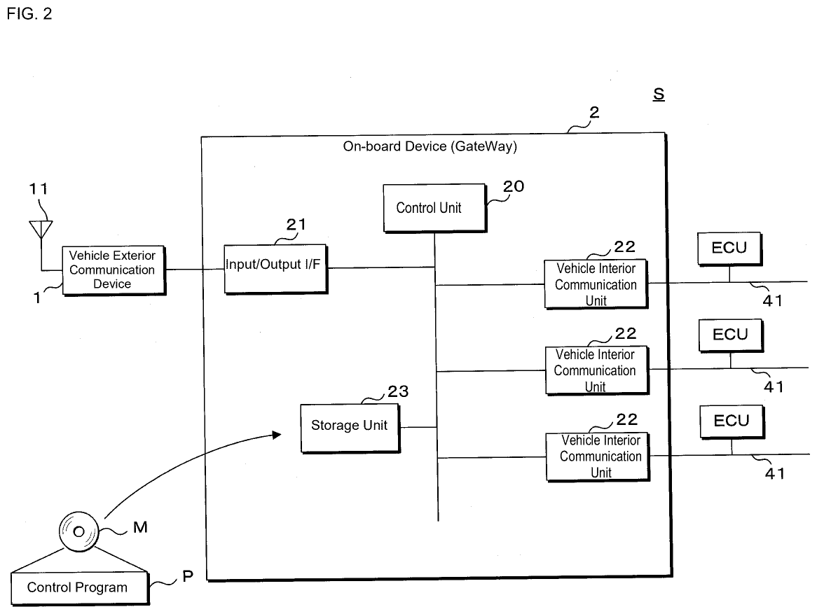

Hereinafter, the embodiment will be described on the basis of the drawings. FIG. 1 is a schematic view illustrating the configuration of an on-board system including an on-board device according to a first embodiment. FIG. 2 is a block diagram illustrating the physical configuration of the on-board device. An on-board system S includes a vehicle exterior communication device 1 and an on-board device 2 mounted on a vehicle C, and transmits an additional program (an OTA module) acquired from an external server SV1 (a program provision device, an OTA server) connected via a vehicle exterior network N to an on-board electronic control unit (ECU) 3 mounted on the vehicle C.

The external server SV1, for example, is a computer such as a server that is connected to the vehicle exterior network N such as the internet or a public telephone network, includes a storage unit such as a random access memory (RAM), a read only memory (ROM), or a hard disk, and corresponds to a vehicle exterior program provision device. In the external server SV1, a program or data for controlling the on-board ECU 3 prepared by a manufacturer or the like of the on-board ECU 3 is stored in the storage unit. The program or the data is transmitted to the vehicle C as an additional program or an update program, and is used to add or update the program or the data of the on-board ECU 3 mounted on the vehicle C, and thus, a software function is added to the vehicle C. The external server SV1 (the program provision device) configured as described above is also referred to as an over the air (OTA) server.

The on-board device 2 functions as a relay device relaying communication data (such as a CAN frame) transmitted/received between the on-board ECUs 3 connected to an on-board network 4. The on-board device 2 is connected to the external server SV1 via the vehicle exterior communication device 1 and the vehicle exterior network N such that communication is available. The on-board device 2 may function as an OTA master that transmits the additional program or the like acquired from the external server SV1 to the on-board ECU 3 to be an applying target, and transmits an activating instruction for applying the transmitted additional program to the on-board ECU 3.

A plurality of on-board ECUs 3 for controlling the vehicle exterior communication device 1, the on-board device 2, and various on-board devices are mounted on the on the vehicle C. The vehicle exterior communication device 1 and the on-board device 2 are connected, for example, by a harness such as a serial cable such that communication is available. The on-board device 2 and the on-board ECU 3 are connected by the on-board network 4 corresponding to a communication protocol such as a control area network (CAN) or Ethernet (registered trademark) such that communication is available.

The vehicle exterior communication device 1 includes a vehicle exterior communication unit (not illustrated) and an input/output interface (I/F) for communicating with the on-board device 2. The vehicle exterior communication unit is a communication device for performing wireless communication by using a mobile communication protocol such as LTE (registered trademark), 4G, 5G, and WiFi (registered trademark), and transmits/receives data with respect to the external server SV1 via an antenna 11 connected to the vehicle exterior communication unit. The communication between the vehicle exterior communication device 1 and the external server SV1, for example, is performed via the vehicle exterior network N such as a public telephone network or the internet.

The input/output I/F of the vehicle exterior communication device 1 is a communication interface for performing, for example, serial communication with the on-board device 2. The vehicle exterior communication device 1 and the on-board device 2 communicate with each other via a harness such as a serial cable connected between the input/output I/Fs. In this embodiment, the vehicle exterior communication device 1 is a device separated from the on-board device 2, and is connected to the device by the input/output I/F or the like such that communication is available, but is not limited thereto. The vehicle exterior communication device 1 may be built in the on-board device 2, as one constituent of the on-board device 2. Alternatively, the vehicle exterior communication device 1 and the on-board device 2 may be connected by the on-board network 4 such as a CAN.

The on-board device 2 includes a control unit 20, a storage unit 23, an input/output I/F 21, and a vehicle interior communication unit 22. The on-board device 2, for example, is a gateway (an on-board relay device) that handles buses (segments) of a plurality of systems such as the on-board ECU 3 of a control system, the on-board ECU 3 of a safety system, and the on-board ECU 3 of a body system, and relays communication between the on-board ECUs 3 between the buses (segments). That is, each communication line 41 configuring a plurality of buses (segments) is connected to the on-board device 2, and the on-board network 4 is composed of a plurality of communication lines 41 (segments) aggregated by the on-board device 2. The on-board device 2 functions as a CAN gateway in the relay of a CAN protocol, and functions as a layer 2 switch or a layer 3 switch in the relay of a TCP/IP protocol. The on-board device 2 may be a power lan box (PLB) also functioning as a power distribution device that distributes and relays power output from a power-supply device such as a secondary battery, and supplies power to an on-board device such as an actuator connected to the own device, in addition to the relay relevant to communication. Alternatively, the on-board device 2 may be configured as one function unit of a body ECU controlling the entire vehicle C. Alternatively, the on-board device 2, for example, may be an integrated ECU that is configured in a central control device such as a vehicle computer, and performs overall control of the vehicle C.

The control unit 20 is composed of a central processing unit (CPU), a micro processing unit (MPU), or the like, and reads out and executes a control program P (a program product) and data stored in advance in the storage unit 23 to perform various types of control processing and arithmetic processing.

The storage unit 23 is composed of a volatile memory element such as a random access memory (RAM), or a non-volatile memory element such as a read only memory (ROM), an electrically erasable programmable ROM (EEPROM), or a flash memory. The control program P, and data that is referred to when processing vehicle information or the like described later are stored in advance in the storage unit 23. Further, various types of data acquired by the control unit 20 from the external server SV1 are stored in the storage unit 23. Further, various types of intermediate data and result data created when the control unit 20 executes various types of arithmetic processing are stored in the storage unit 23. Such various types of intermediate data and result data, for example, include an ECU software version list, ECU communication definition information, a vehicle communication definition list, a frame transmission/reception comparison chart, a frame version variation chart, frame definition information, a conversion rule preparation task chart, and a conversion rule table. The details thereof will be described later. The control program P (the program product) stored in the storage unit 23 may be the control program P (the program product) read out from a recording medium M that is readable by the on-board device 2. In addition, the control program P may be downloaded from an external computer, which is not illustrated, connected to a communication network, which is not illustrated, and stored in the storage unit.

The input/output I/F 21, as with the input/output I/F of the vehicle exterior communication device 1, for example, is a communication interface for serial communication. The on-board device 2 is connected to the vehicle exterior communication device 1, a display device such as a display, an IG switch that starts or stops the vehicle C, or the like via the input/output I/F such that communication is available.

The vehicle interior communication unit 22, for example, is an input/output interface using a communication protocol such as a CAN or Ethernet (registered trademark), and the control unit 20 and the on-board device such as the on-board ECU 3 or another relay device connected to the on-board network 4 communicate with each other via the vehicle interior communication unit 22. A plurality of (in this embodiment, three) vehicle interior communication units 22 are provided, and the communication line 41 (a segment, a CAN bus) configuring the on-board network 4 is connected to each of the vehicle interior communication units 22.

The on-board ECU 3, as with the on-board device 2, includes a control unit (CPU), a storage unit, and a vehicle interior communication unit. The storage unit is composed of a volatile memory element such as a random access memory (RAM), or a non-volatile memory element such as a read only memory (ROM), an electrically erasable programmable ROM (EEPROM), or a flash memory, and stores the program or the data of the on-board ECU 3. The program or the data is a target to be added by a program that is transmitted from the program provision device and relayed by the on-board device 2. The vehicle interior communication unit of the on-board ECU 3, as with the on-board device 2, for example, is composed of a CAN transceiver, an Ethernet PHY part, or the like, and communicates with the on-board device 2 via the vehicle interior communication unit.

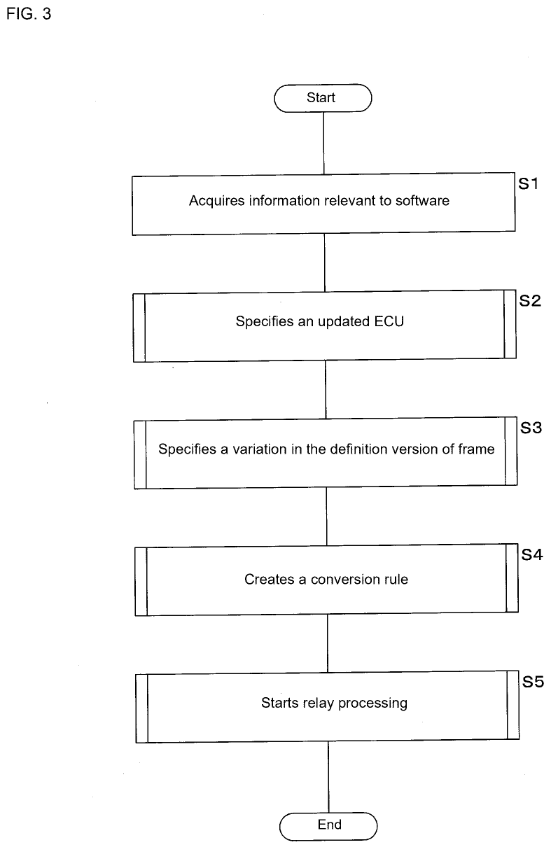

FIG. 3 is a flowchart illustrating the (main) processing of the control unit 20 of the on-board device 2. The control unit 20 of the on-board device 2, for example, performs the following processing when the vehicle C is in an activated state (for example, the IG switch is turned on) from a stopped state (for example, the IG switch is turned off). That is, the control unit 20 of the on-board device 2 may perform the following processing by using the activation of the vehicle C (the IG switch is turned on) as a trigger.

The control unit 20 of the on-board device 2 acquires information relevant to software (S1). The control unit 20 of the on-board device 2 communicates with each of the on-board ECUs 3 connected to the on-board network 4 via the communication line 41 such as a CAN bus, acquires version information (ECU version information) of the software implemented on the on-board ECU 3, and stores the version information in the storage unit 23. The version information (ECU version information) of the software transmitted from the on-board ECU 3 includes the version of the software implemented on the on-board ECU 3.

The control unit 20 of the on-board device 2 specifies an updated ECU in which the software is updated (S2). The control unit 20 of the on-board device 2 specifies the updated ECU, on the basis of the ECU software version list stored in the storage unit 23 at the current point, and the version information (the ECU version information) of the software acquired and aggregated from all the on-board ECUs 3 connected to the on-board network 4. In addition, the control unit 20 of the on-board device 2 updates the ECU software version list by reflecting the specified updated ECU.

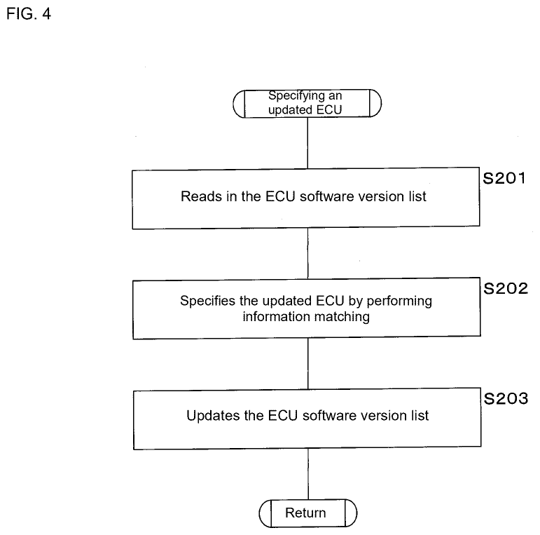

FIG. 4 is a flowchart illustrating the processing (specifying the updated ECU) of the control unit 20 of the on-board device 2. The control unit 20 of the on-board device 2 performs the following processing when specifying the updated ECU.

The control unit 20 of the on-board device 2 reads in the ECU software version list (S201). The control unit 20 of the on-board device 2 reads in the ECU software version list stored in the storage unit 23 at the current point, with reference to the storage unit 23. The ECU software version list at the current point is an ECU software version list that is created or updated on the basis of the version information (the ECU version information) of the software acquired and aggregated from all the on-board ECUs 3 before the current processing is performed, that is, when the IG switch is previously turned on or turned off.

The control unit 20 of the on-board device 2 specifies the updated ECU by performing information matching (S202). The control unit 20 of the on-board device 2 extracts a difference or a variation by matching or comparing the read ECU software version list with the currently aggregated version information (ECU version information) of the software, and specifies the on-board ECU 3 with a variation as the updated ECU in which the version of the software is updated.

The control unit 20 of the on-board device 2 updates the ECU software version list (S203). The control unit 20 of the on-board device 2 updates the software version list stored in the storage unit 23 by reflecting the specified updated ECU.

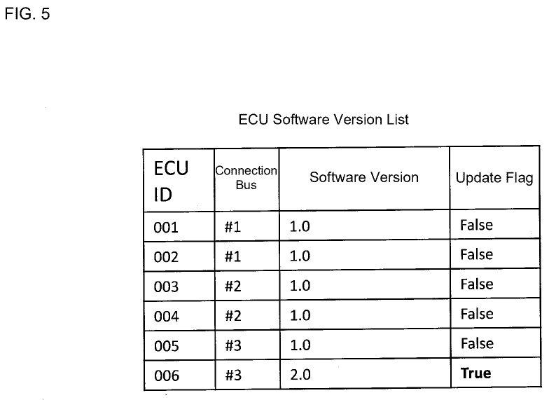

FIG. 5 is an explanatory diagram illustrating respects (the ECU software version list) relevant to the software implemented on the on-board ECU 3. The ECU software version list includes an ECUID, a connection bus, a software version, and an update flag, as a control item.

In the control item of the ECUID, an ID (an identification number) uniquely indicating the on-board ECU 3 is stored. In the control item of the connection bus, the number of the communication line 41 such as a CAN bus to which the on-board ECU 3 is connected is stored. In the control item of the software version, the version number of the software of the implemented on the on-board ECU 3 is stored. In the control item of the update flag, a flag indicating whether the on-board ECU 3 is the updated ECU (False: the on-board ECU is not the updated ECU, True: the on-board ECU is the updated ECU) is stored. In this embodiment, it is described that the version of the software of the on-board ECU 3 with an ECUID of 006 is upgraded to 2.0 from 1.0, and the on-board ECU is specified as the updated ECU.

The control unit 20 of the on-board device 2 specifies a variation in the definition version of frame transmitted/received by the updated software (S3). The control unit 20 of the on-board device 2 specifies one or more frames transmitted/received by the updated software, and specifies a variation in the definition version of the frame (detects a version discrepancy in communication definition) in the on-board ECU 3 (a transmission ECU) transmitting the frame and the on-board ECU 3 (a reception ECU) receiving the frame. In a case where the updated ECU is the transmission ECU, the reception ECU corresponds to an opponent ECU. In a case where the updated ECU is the reception ECU, the transmission ECU corresponds to the opponent ECU.

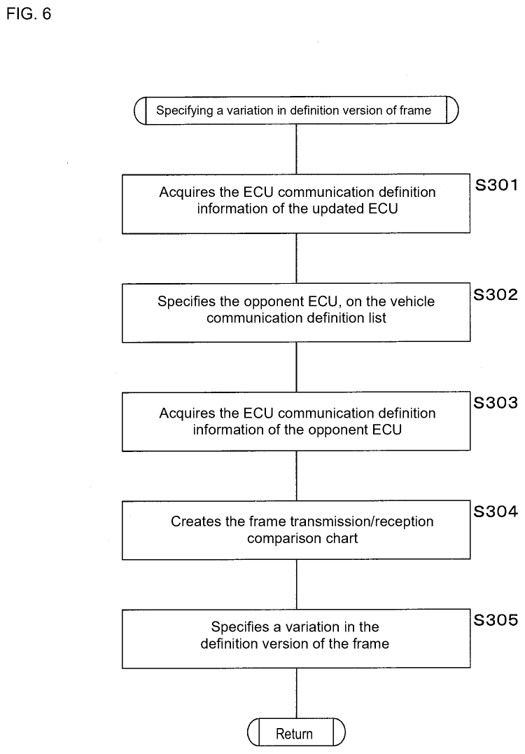

FIG. 6 is a flowchart illustrating the processing (specifying a variation in the definition version of the frame) of the control unit 20 of the on-board device 2. The control unit 20 of the on-board device 2 performs the following processing when specifying a variation in the definition version of the frame.

The control unit 20 of the on-board device 2 acquires the ECU communication definition information of the updated ECU (S301). The control unit 20 of the on-board device 2 acquires the ECU communication definition information from the updated ECU by making an inquiry into the updated ECU, and stores the ECU communication definition information in the storage unit 23.

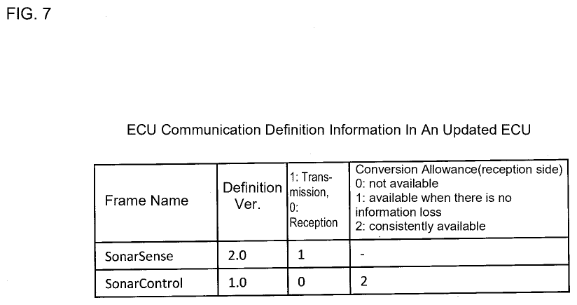

FIG. 7 is an explanatory diagram illustrating respects (the ECU communication definition information) relevant to the frame transmitted/received when the software is executed in the updated ECU. The ECU communication definition information includes a frame name, definition Ver, transmission/reception (a transmission/reception flag), and a conversion allowance, as a control item.

In the control item of the frame name, a name or a type uniquely indicating the frame transmitted/received between the on-board ECUs 3 via the on-board network 4 is stored. In the control item of the definition Ver, the number of the definition version of the frame is stored. In a case where the definition version is changed, a data length, a transmission period, a signal definition, or the like may be changed. The version number (the number of the definition version) may be stored in the frame. In the transmission/reception (the transmission/reception flag), the transmission/reception flag (1: transmission, 0: reception) indicating whether the frame is transmitted or received is stored.

In the control item of the conversion allowance, a level (0: not available, 1: available when there is no information loss, 2: consistently available) indicating the conversion allowance when the frame is received is stored. The level of the conversion allowance is determined in accordance with whether the reception ECU causes a control problem in information obtained by converting and relaying the transmission frame of the transmission ECU. In the reception ECU in which a slight variation in accuracy, such as a function relevant to safety, may cause a serious problem, a strict value (0: not available) may be set. In a case where the conversion allowance is 0 (not available), the conversion of the frame is not at all. In a case where the conversion allowance is 2 (consistently available), the conversion of the frame is consistently allowed.

In a case where the conversion allowance is 1 (available when there is no information loss), the conversion of the frame is allowed by performing the conversion of the frame when there is no information loss. That is, in a case where in an information amount processed in unit time, the information amount of the transmission ECU (the transmission side) is larger than the information amount of the reception ECU (the reception side), there is no information loss in the reception ECU (the reception side) even when the on-board device 2 reduces the information amount of the transmission ECU (the transmission side) to the information amount of the reception ECU (the reception side). As described above, in order to increase the information amount processed in unit time, for example, it is valid to shorten a transmission period, lengthen the data length of a payload in a single frame, or make the resolution of data included in the payload (such as a value measured by a sensor or the like) finer.

The control unit 20 of the on-board device 2 specifies the opponent ECU, on the vehicle communication definition list (S302). In each of the frames, information relevant to the on-board ECU 3 (the transmission ECU, the reception ECU) transmitting/receiving the frame is stored in the vehicle communication definition list, and the vehicle communication definition list is stored in advance in the storage unit 23 of the on-board device 2. The control unit 20 of the on-board device 2, in each of the frames (the frame names), specifies the opponent ECU (with an ECUID of 001) to be the communication opponent of the updated ECU (with an ECUID of 006), with reference to the vehicle communication definition list.

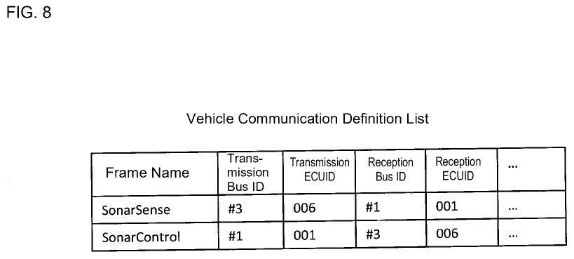

FIG. 8 is an explanatory diagram illustrating respects (the vehicle communication definition list) relevant to the combination of the on-board ECUs 3 transmitting/receiving the frames. The vehicle communication definition list includes a frame name, a transmission bus ID, a transmission ECUID, a reception bus ID, and a reception ECUID, as a control item. There may be a plurality of combinations of the reception bus ID and the reception ECUID.

In the control item of the frame name, a name or the like uniquely indicating the frame is stored. In the control item of the transmission bus ID, the number of the communication line 41 such as a CAN bus to which the transmission ECU transmitting the frame is connected is stored. In the control item of the transmission ECUID, the ECUID of the transmission ECU transmitting the frame is stored. In the control item of the reception bus ID, the number of the communication line 41 such as a CAN bus to which the reception ECU receiving the frame is connected is stored. In the control item of the reception ECUID, the ECUID of the reception ECU receiving the frame is stored.

The control unit 20 of the on-board device 2 acquires the ECU communication definition information of the opponent ECU (S303). The control unit 20 of the on-board device 2 acquires the ECU communication definition information from the opponent ECU by making an inquiry into the opponent ECU, and stores the ECU communication definition information in the storage unit 23.

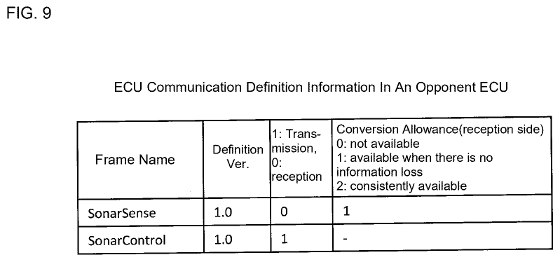

FIG. 9 is an explanatory diagram illustrating respects (the ECU communication definition information) relevant to the frame transmitted/received when the software is executed in the opponent ECU. The control item of the ECU communication definition information is commonalized or standardized in all the on-board ECUs 3, and the control item of the ECU communication definition information of the opponent ECU is the same as the control item of the ECU communication definition information of the updated ECU.

The control unit 20 of the on-board device 2 creates the frame transmission/reception comparison chart (S304). The control unit 20 of the on-board device 2 synthesizes three types of information obtained so far, that is, the ECU communication definition information of the updated ECU, the vehicle communication definition list, and the ECU communication definition information of the opponent ECU to prepare the frame transmission/reception comparison chart.

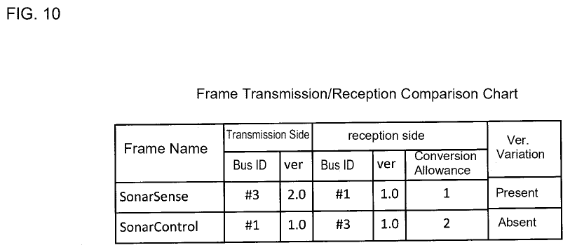

FIG. 10 is an explanatory diagram illustrating respects (the frame transmission/reception comparison chart) relevant to the similarities and variations in the definition versions of the frames. The frame transmission/reception comparison chart includes a frame name, a bus ID and Ver on the transmission side, a bus ID and Ver on the reception side, a conversion allowance, and a Ver variation, as a control item.

In the control item of the frame name, a name or the like uniquely indicating the frame is stored. In the control item of the bus ID on the transmission side, the number of the communication line 41 such as a CAN bus to which the transmission ECU is connected is stored. In the control item of Ver on the transmission side, the number of the definition version of the frame of the transmission ECU is stored. In the control item of the bus ID on the reception side, the number of the communication line 41 such as a CAN bus to which the reception ECU is connected is stored. In the control item of Ver on the reception side, the number of the definition version of the frame of the reception ECU is stored. In the control item of the conversion allowance, the level indicating the conversion allowance when the frame is received is stored. In the control item of the Ver variation, a result (Variation: present/absent) indicating whether there is a variation between Ver on the transmission side and Ver on the reception side, determined by the control unit 20 of the on-board device 2, is stored.

The control unit 20 of the on-board device 2 specifies a variation in the definition version of the frame, in the frame transmission/reception comparison chart (S305). The control unit 20 of the on-board device 2 compares the transmission side Ver with the reception side Ver for the individual frame in the frame transmission/reception comparison chart, and sets a Ver variation flag “present” for each frame when there is a variation. The control unit 20 of the on-board device 2 specifies the frame with a variation in the definition version, in the individual frame, on the basis of the frame transmission/reception comparison chart in which the flag is set as described above.

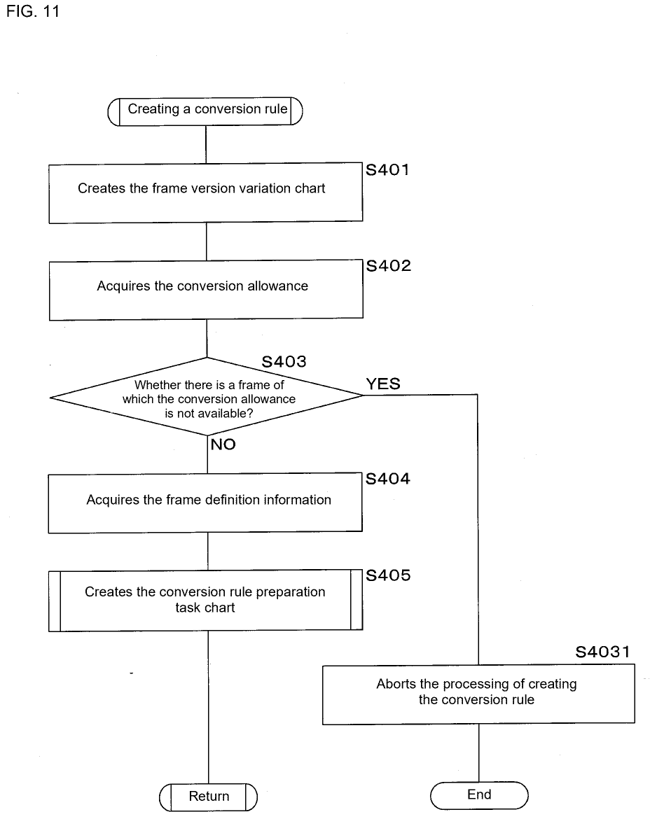

The control unit 20 of the on-board device 2 creates a conversion rule for the frame with a variation in the definition version (S4). FIG. 11 is a flowchart illustrating the processing (creating the conversion rule) of the control unit 20 of the on-board device 2. The control unit 20 of the on-board device 2 performs the following processing when creating the conversion rule.

The control unit 20 of the on-board device 2 creates the frame version variation chart (S401). The control unit 20 of the on-board device 2 extracts only the row in which the Ver variation flag is “present”, in the frame transmission/reception comparison chart, to prepare the frame version variation chart.

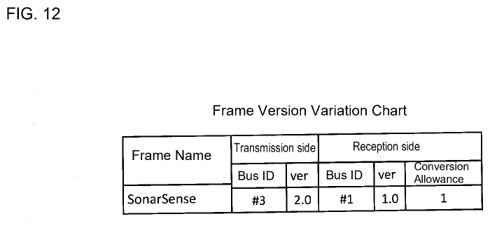

FIG. 12 is an explanatory diagram illustrating respects (the frame version variation chart) relevant to the frames with different definition versions. The frame version variation chart includes a frame name, a bus ID and Ver on the transmission side, a bus ID and Ver on the reception side, and a conversion allowance, as a control item.

In the control item of the frame name, a name or the like uniquely indicating the frame is stored. In the control item of the bus ID on the transmission side, the number of the communication line 41 such as a CAN bus to which the transmission ECU is connected is stored. In the control item of Ver on the transmission side, the number of the definition version of the frame of the transmission ECU is stored. In the control item of the bus ID on the reception side, the number of the communication line 41 such as a CAN bus to which the reception ECU is connected is stored. In the control item of Ver on the reception side, the number of the definition version of the frame of the reception ECU is stored. In the control item of the conversion allowance, the level indicating the conversion allowance when the frame is received is stored.

The control unit 20 of the on-board device 2 acquires the conversion allowance in the frame version variation chart (S402). The control unit 20 of the on-board device 2 checks or extracts the value (the level) of the conversion allowance for the transmission side and the reception side in each row of the frame version variation chart.

The control unit 20 of the on-board device 2, in any frame, determines whether there is a frame of which the conversion allowance is not available (S403). The control unit 20 of the on-board device 2, in one or more frame names listed in the frame version variation chart, determines whether there is one frame of which the conversion allowance is not available “Conversion Allowance==0 (not available)”.

In a case where there is the frame of which the conversion allowance is not available (S403: YES), the control unit 20 of the on-board device 2 aborts the processing of creating the conversion rule (S4031). In a case where there is one frame of which the conversion allowance is not available, in one or more frame names listed in the frame version variation chart, the control unit 20 of the on-board device 2 aborts the processing of creating the conversion rule. That is, the control unit 20 of the on-board device 2 determines that the conversion relay is not available, displays that the updated ECU is invalid, and outputs information for urging a version change or the like on a user (the operator of the vehicle C).

In a case where there is no frame of which the conversion allowance is not available (S403: NO), the control unit 20 of the on-board device 2 acquires the frame definition information (S404). In a case where there is no frame of which the conversion allowance is not available, in the one or more frame names listed in the frame version variation chart, the control unit 20 of the on-board device 2 extracts each type of frame definition information corresponding to each of one or more frame names listed in the frame version variation chart. The frame definition information is stored in advance in the storage unit 23 of the on-board device 2. Alternatively, the control unit 20 of the on-board device 2 may acquire the latest frame definition information from the updated ECU.

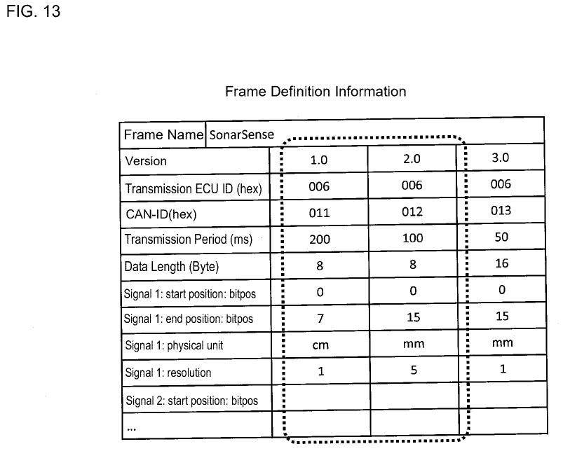

FIG. 13 is an explanatory diagram illustrating respects (the frame definition information) relevant to the definition information in which the communication specification item of the frame is defined. In this embodiment, a communication specification item (frame definition information) of a frame with a frame name of SonarSense will be exemplified. The control item in the frame definition information includes the version (the definition version of the frame) that is a horizontal item, and a vertical item including a plurality of communication specification items, and is configured as a matrix structure of the horizontal item and the vertical item. In the control item of the version (the definition version of the frame) that is the horizontal item, the value (1.0, 2.0, 3.0, or the like) of the definition version of the frame is stored. For each definition version of the frame, the values or the contents of the plurality of communication specification items that are the vertical item are stored.

The plurality of communication specification items that are the vertical item includes Signal 1: start position, Signal 1: end position, Signal 1: physical unit, and Signal 1: resolution, as respects relevant to the transmission ECUID, CAN-ID, the transmission period, the data length, and the resolution. Such respects relevant to the resolution may be included for other signals (Signal 2, Signal 3, and the like). Further, the communication specification item may include an offset value.

In the control item of the transmission ECUID, the ID of the on-board ECU 3 (the transmission ECU) transmitting the frame is stored. In the control item of CAN-ID, a message ID when the frame is a CAN message is stored. In the control item of the transmission period, a period when the frame is transmitted is stored. In the control item of the data length, the data length of the payload included in the frame is stored.

In Signal 1: start position, a start bit number when storing Signal 1 is stored. In Signal 1: end position, an end bit number when storing Signal 1 is stored. In Signal 1: physical unit, the physical unit (cm, mm, or the like) of the value of the signal is stored. In Signal 1: resolution, the resolution of the value of the signal is stored.

The control unit 20 of the on-board device 2 creates the conversion rule preparation task chart (S405). The control unit 20 of the on-board device 2 creates the conversion rule in each of the communication specification items, in the definition version of the frame of the updated ECU and the definition version of the frame of the opponent ECU, on the basis of the frame definition information, and integrates each of the created conversion rules to create the conversion rule preparation task chart. In this embodiment, as an example of the communication specification item, processing relevant to creating the conversion rule of an identifier (CAN-ID), the period, the data length, and the signal (the resolution) will be described.

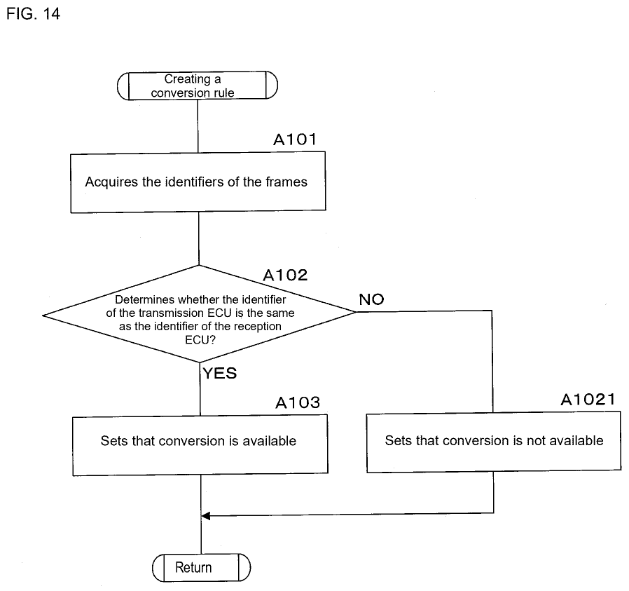

FIG. 14 is a flowchart illustrating processing (determining whether the conversion of the identifier is available) of the control unit 20 of the on-board device 2. The control unit 20 of the on-board device 2 performs the following processing when creating the conversion rule of the identifier.

The control unit 20 of the on-board device 2 acquires the identifiers of the frames of the transmission ECU and the reception ECU (A101). The control unit 20 of the on-board device 2 extracts CAN-ID (the identifier of the frame) on each of the transmission side and the reception side from the conversion rule creation task chart.

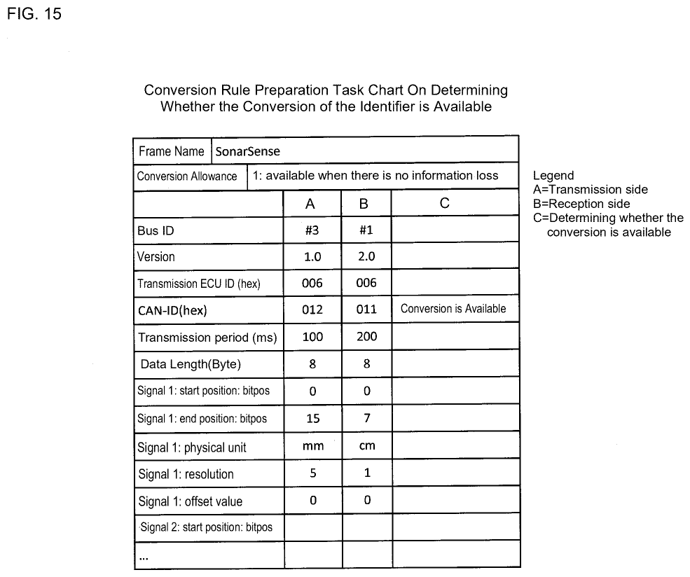

FIG. 15 is an explanatory diagram illustrating respects (the conversion rule preparation task chart) relevant to determining whether the conversion of the identifier is available. The control unit 20 of the on-board device 2 creates the conversion rule preparation task chart by using the ECU communication definition information of the updated ECU, the ECU communication definition information of the opponent ECU, the frame definition information, and the vehicle communication definition list. The control item of the conversion rule preparation task chart includes a transmission side, a reception side, and determining whether conversion is available, which are a horizontal item, a bus ID, a version, a transmission ECUID, CAN-ID, a transmission period, a data length, Signal 1: start position, Signal 1: end position, Signal 1: physical unit, Signal 1: resolution, and Signal 1: offset value, which are a vertical item, and is configured in the shape of a matrix.

In the control item of the bus ID, the number of the communication line 41 such as a CAN bus to which the transmission ECU is connected and the number of the communication line 41 such as a CAN bus to which the reception ECU is connected are stored for the horizontal item of the transmission side and the reception side. In the control item of the version, the definition version of the frame of the transmission ECU and the definition version of the frame of the reception ECU are stored for the horizontal item of the transmission side and the reception side. In the control item of the transmission ECUID, the ID of the transmission ECU and the ID of the reception ECU are stored for the horizontal item of the transmission side and the reception side. In the control item of CAN-ID, the identifier (the message ID) of the frame transmitted by the transmission ECU and the identifier (the message ID) of the frame received by the reception ECU are stored for the horizontal item of the transmission side and the reception side. In the control item of the transmission period, the transmission period of the transmission ECU and the reception period of the reception ECU are stored for the horizontal item of the transmission side and the reception side. In the control item of the data length, the data length of the frame of the transmission ECU and the data length of the frame of the reception ECU are stored for the horizontal item of the transmission side and the reception side.

In the control item of Signal 1: start position, the start bit number of the frame of the transmission ECU and the start bit number of the frame of the reception ECU are stored for the horizontal item of the transmission side and the reception side. In the control item of Signal 1: end position, the end bit number of the frame of the transmission ECU and the end bit number of the frame of the reception ECU are stored for the horizontal item of the transmission side and the reception side. In the control item of Signal 1: physical unit, the physical unit of the signal stored in the frame of the transmission ECU and the physical unit of the signal stored in the frame of the reception ECU are stored for the horizontal item of the transmission side and the reception side. In the control item of Signal 1: resolution, the resolution of the signal stored in the frame of the transmission ECU and the resolution of the signal stored in the frame of the reception ECU are stored for the horizontal item of the transmission side and the reception side. In the control item of Signal 1: offset value, the offset value stored in the frame of the transmission ECU and the offset value stored in the frame of the reception ECU are stored for the horizontal item of the transmission side and the reception side.

The control unit 20 of the on-board device 2 determines whether the identifier of the transmission ECU is the same as the identifier of the reception ECU (A102). The control unit 20 of the on-board device 2 determines whether the identifier of the transmission ECU is not the same as the identifier of the reception ECU (Transmission Side CAN-ID≠Reception Side CAN-ID).

In a case where the identifiers are not the same (A102: YES), the control unit 20 of the on-board device 2 sets that conversion is available, in the item of the identifier in the conversion rule preparation task chart (A103). In a case where the identifiers are not the same, the control unit 20 of the on-board device 2 sets that conversion is available (conversion OK), in the item of the identifier in the conversion rule preparation task chart. In this case, the reason why the control unit 20 of the on-board device 2 is capable of setting that conversion is available (conversion OK) without any condition is that there is no information loss in CAN-ID conversion, and a case where the conversion allowance is not available in both of transmission and reception is already excluded.

In a case where the identifiers are the same (A102: NO), the control unit 20 of the on-board device 2 sets that conversion is not available, in the item of the identifier in the conversion rule preparation task chart (A1021). In a case where the identifiers are the same, the control unit 20 of the on-board device 2 sets that conversion is not available, in the item of the identifier in the conversion rule preparation task chart.

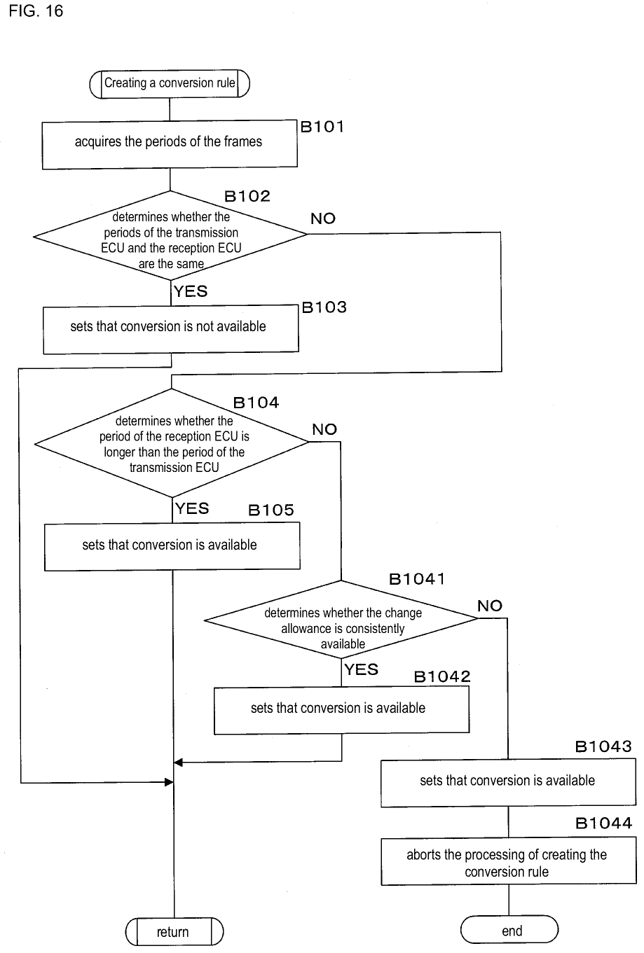

FIG. 16 is a flowchart illustrating the processing (determining whether the conversion of the period is available) of the control unit 20 of the on-board device 2. The control unit 20 of the on-board device 2 performs the following processing when creating the conversion rule of the period.

The control unit 20 of the on-board device 2 acquires the periods of the frames of the transmission ECU and the reception ECU (B101). The control unit 20 of the on-board device 2 extracts the transmission period (Transmission Side: transmission period, Reception Side: reception period) of each of the transmission side (the transmission ECU) and the reception side (the reception ECU) from the conversion rule creation task chart.

The control unit 20 of the on-board device 2 determines whether the periods of the transmission ECU and the reception ECU are the same (B102). The control unit 20 of the on-board device 2 determines whether the periods of the transmission ECU and the reception ECU are the same (Transmission Side: Transmission Period==Reception Side: Reception Period (a transmission period assumed by the reception side for the transmission side)).

In a case where the periods are the same (B102: YES), the control unit 20 of the on-board device 2 sets that conversion is not available (conversion is unnecessary), in the item of the period in the conversion rule preparation task chart (B103). In a case where the transmission/reception periods on the transmission side (the transmission ECU) and the reception side (the reception ECU) are the same, the control unit 20 of the on-board device 2 sets that conversion is not available, in the item of the period in the conversion rule preparation task chart.

In a case where the periods are not the same (B102: NO), the control unit 20 of the on-board device 2 determines whether the period of the reception ECU is longer than the period of the transmission ECU (B104). In a case where the transmission/reception periods on the transmission side (the transmission ECU) and the reception side (the reception ECU) are not the same, the control unit 20 of the on-board device 2 determines whether the period of the reception ECU is longer than the period of the transmission ECU (Reception Side: Reception Period>Transmission Side: Transmission Period).

In a case where the period of the reception ECU is longer than the period of the transmission ECU (B104: YES), the control unit 20 of the on-board device 2 sets that conversion is available, in the item of the period in the conversion rule preparation task chart (B105). In a case where the period of the reception ECU is longer than the period of the transmission ECU, the control unit 20 of the on-board device 2 sets that conversion is available, in the item of the period in the conversion rule preparation task chart. Since update is more frequently performed than an information update period expected by the reception side, and there is no information loss, the control unit 20 of the on-board device 2 is capable of setting that conversion is available.

In a case where the period of the reception ECU is not longer than the period of the transmission ECU (B104: NO), the control unit 20 of the on-board device 2 determines whether the change allowance is consistently available (B1041). In a case where the period of the reception ECU is not greater, that is, smaller than the period of the transmission ECU, the control unit 20 of the on-board device 2 determines whether the change allowance is consistently available. Since the update period is longer than the information update period expected by the reception side, and there is an information loss, the control unit 20 of the on-board device 2 determines whether the change allowance is consistently available.

In a case where the change allowance is consistently available (B1041: YES), the control unit 20 of the on-board device 2 sets that the conversion is available, in the item of the period in the conversion rule preparation task chart (B1042). In a case where the change allowance is consistently available, it is set that the conversion is available, in the item of the period in the conversion rule preparation task chart. The control unit 20 of the on-board device 2 may return to the main routine (S4), after the processing of B103, B105, or B1042.

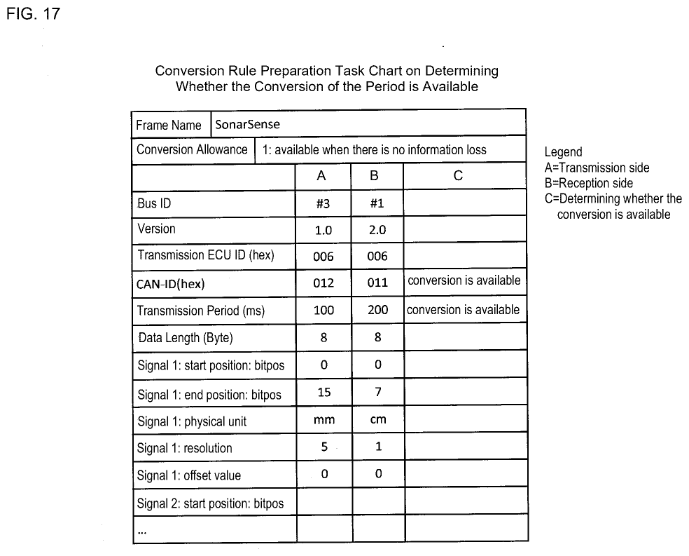

FIG. 17 is an explanatory diagram illustrating respects (the conversion rule preparation task chart) relevant to determining whether the conversion of the period is available. The control unit 20 of the on-board device 2 sets that conversion is available (conversion OK) by storing that the conversion is available, in the control item of determining whether the conversion is available for the transmission period in the conversion rule preparation task chart.

In a case where the change allowance is not consistently available (B1041: NO), the control unit 20 of the on-board device 2 sets that conversion is not available, in the item of the period in the conversion rule preparation task chart (B1043). The control unit 20 of the on-board device 2 aborts the processing of creating the conversion rule (B1044). In a case where the change allowance is not consistently available, it is set that conversion is not available by storing that the conversion is not available, in the control item of determining whether the conversion is available for the transmission period in the conversion rule preparation task chart. In addition, the control unit 20 of the on-board device 2 aborts the processing of creating the conversion rule. That is, the control unit 20 of the on-board device 2 determines that conversion relay is not available, displays that the updated ECU is invalid, and outputs information for urging the version change or the like on the user (the operator of the vehicle C).

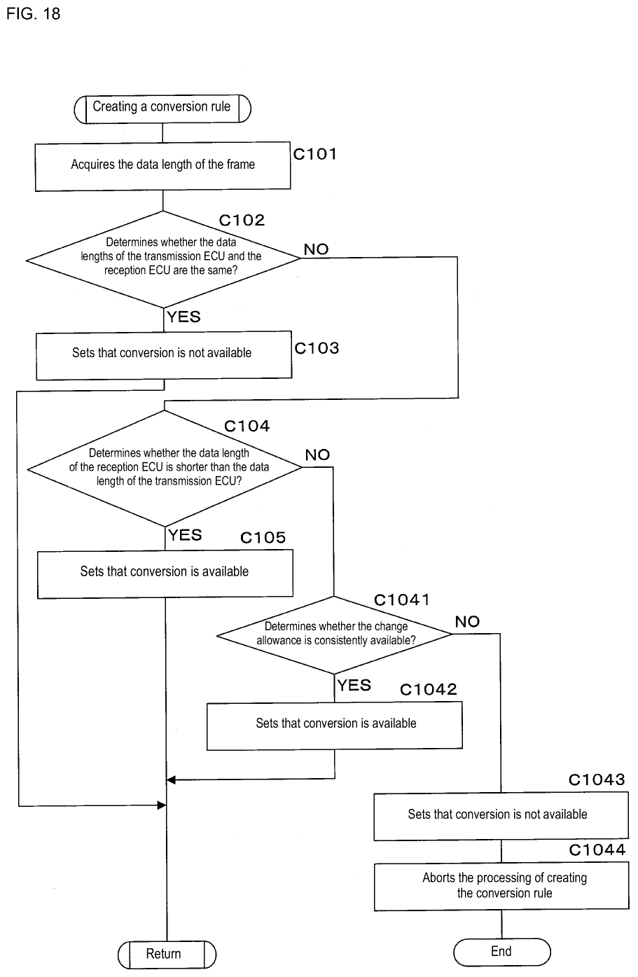

FIG. 18 is a flowchart illustrating processing (determining whether the conversion of the data length is available) of the control unit 20 of the on-board device 2. The control unit 20 of the on-board device 2 performs the following processing when creating the conversion rule of the data length.

The control unit 20 of the on-board device 2 acquires the data length of the frame of the transmission ECU and the reception ECU (C101). The control unit 20 of the on-board device 2 extracts the data length of each of the transmission side (the transmission ECU) and the reception side (the reception ECU) from the conversion rule creation task chart.

The control unit 20 of the on-board device 2 determines whether the data lengths of the transmission ECU and the reception ECU are the same (C102). The control unit 20 of the on-board device 2 determines whether the data lengths of the transmission ECU and the reception ECU are the same (Transmission Side: Data Length==Reception Side: Data Length).

In a case where the data lengths are the same (C102: YES), the control unit 20 of the on-board device 2 sets that conversion is not available, in the item of the data length in the conversion rule preparation task chart (C103). In a case where the data lengths of the transmission side (the transmission ECU) and the reception side (the reception ECU) are the same, the control unit 20 of the on-board device 2 sets that conversion is not available, in the item of the data length in the conversion rule preparation task chart.

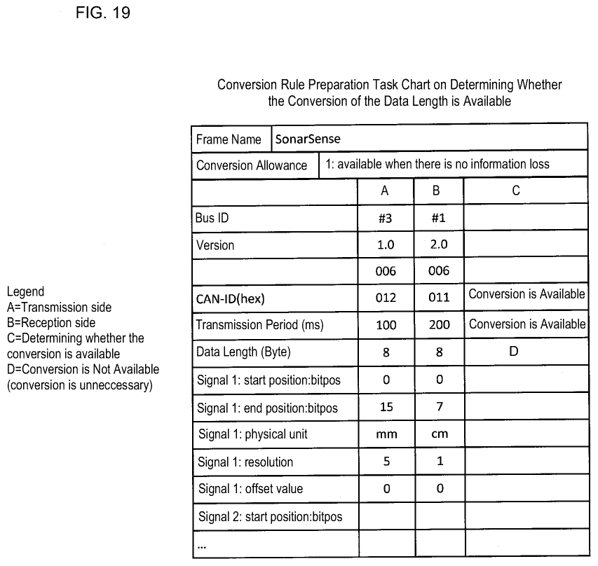

FIG. 19 is an explanatory diagram illustrating respects (the conversion rule preparation task chart) relevant to determining whether the conversion of the data length is available. The control unit 20 of the on-board device 2, as an example, sets that conversion is not available by storing that the conversion is not available, in the control item of determining whether conversion is available for the data length in the conversion rule preparation task chart.

In a case where the data lengths are not the same (C102: NO), the control unit 20 of the on-board device 2 determines whether the data length of the reception ECU is shorter than the data length of the transmission ECU (C104). In a case where the data lengths of the transmission side (the transmission ECU) and the reception side (the reception ECU) are not the same, the control unit 20 of the on-board device 2 determines whether the data length of the reception ECU is shorter than the data length of the transmission ECU (Reception Side Data Length<Transmission Side Data Length).

In a case where the data length of the reception ECU is shorter than the data length of the transmission ECU (C104: YES), the control unit 20 of the on-board device 2 sets that conversion is available, in the item of the data length in the conversion rule preparation task chart (C105). In a case where the data length of the reception ECU is shorter than the data length of the transmission ECU, the control unit 20 of the on-board device 2 sets that conversion is available, in the item of the data length in the conversion rule preparation task chart. Since the data length is longer than the data length expected by the reception side, and there is no information loss, the control unit 20 of the on-board device 2 is capable of setting that conversion is available.

In a case where the data length of the reception ECU is not shorter than the data length of the transmission ECU (C104: NO), the control unit 20 of the on-board device 2 determines whether the change allowance is consistently available (C1041). In a case where the data length of the reception ECU is not shorter, that is, longer than the data length of the transmission ECU, the control unit 20 of the on-board device 2 determines whether the change allowance is consistently available. Since the data length is shorter than the data length expected by the reception side, and there is no information loss, the control unit 20 of the on-board device 2 determines whether the change allowance is consistently available.

In a case where the change allowance is consistently available (C1041: YES), the control unit 20 of the on-board device 2 sets that conversion is available, in the item of the data length in the conversion rule preparation task chart (C1042). In a case where the change allowance is consistently available, it is set that the conversion is available, in the item of the data length in the conversion rule preparation task chart. The control unit 20 of the on-board device 2 may return to the main routine (S4), after the processing of C103, C105, or C1042.

In a case where the change allowance is not consistently available (C1041: NO), the control unit 20 of the on-board device 2 sets that conversion is not available, in the item of the data length in the conversion rule preparation task chart (C1043). The control unit 20 of the on-board device 2 aborts the processing of creating the conversion rule (C1044). In a case where the change allowance is not consistently available, it is set that conversion is not available by storing that the conversion is not available, in the control item of determining whether the conversion is available for the data length in the conversion rule preparation task chart. In addition, the control unit 20 of the on-board device 2 aborts the processing of creating the conversion rule. That is, the control unit 20 of the on-board device 2 determines that conversion relay is not available, displays that the updated ECU is invalid, and outputs information for urging the version change or the like on the user (the operator of the vehicle C).

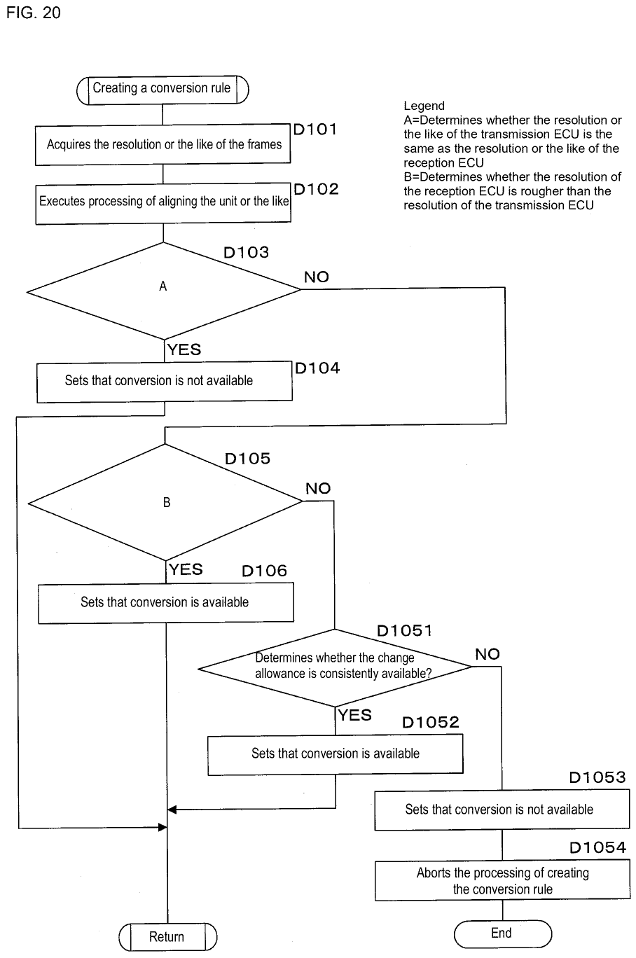

FIG. 20 is a flowchart illustrating processing (determining whether the conversion of the signal is available) of the control unit 20 of the on-board device 2. The control unit 20 of the on-board device 2 performs the following processing when creating the conversion rule of the signal (the resolution). In a case where there are a plurality of signals (Signal 1, Signal 2, ⋅), the control unit 20 of the on-board device 2 repeatedly executes processing for Signal 1, and then, for the subsequent signals (Signal 2, ⋅).

The control unit 20 of the on-board device 2 acquires the resolution or the like of the frames of the transmission ECU and the reception ECU (D101). The control unit 20 of the on-board device 2 extracts the resolution or the like of the transmission side (the transmission ECU) and the reception side (the reception ECU), that is, signal definition information (Signal 1: start position, Signal 1: end position, Signal 1: physical unit, Signal 1: resolution, Signal 1: offset value) relevant to the signal from the conversion rule creation task chart. In this case, the offset value may be defined by a calculus equation “Value of Signal=(Physical Value/Resolution)−Offset Value”. The physical unit may include conversion between units such as Celsius and Fahrenheit, and meter and inch.

The control unit 20 of the on-board device 2 executes processing of aligning the unit or the like of the resolution (D102). The control unit 20 of the on-board device 2 executes processing for enabling the resolution to be compared by aligning the unit of the signal definition. The processing, for example, includes processing of calculating the physical resolution of the signal, and calculating the physical maximum value and the physical minimum value of the signal.

The control unit 20 of the on-board device 2 determines whether the resolution or the like of the transmission ECU is the same as the resolution or the like of the reception ECU (D103). The control unit 20 of the on-board device 2 determines whether the resolution or the like of the transmission ECU is the same as the resolution or the like of the reception ECU (Transmission Side: Resolution and Others==Reception Side: Resolution and Others).

In a case where the resolution or the like of the transmission ECU is the same as the resolution or the like of the reception ECU (D103: YES), the control unit 20 of the on-board device 2 sets that conversion is not available, in the item of the resolution or the like in the conversion rule preparation task chart (D104). In a case where the resolution or the like of the transmission side (the transmission ECU) is the same as the resolution or the like of the reception side (the reception ECU), the control unit 20 of the on-board device 2 sets that conversion is not available, in the item of the resolution or the like (the signal definition information) in the conversion rule preparation task chart.

In a case where the resolution or the like of the transmission ECU is not the same as the resolution or the like of the reception ECU (D103: NO), the control unit 20 of the on-board device 2 determines whether the resolution of the reception ECU is rougher than the resolution of the transmission ECU (D105). In a case where the resolution or the like of the transmission side (the transmission ECU) is not the same as the resolution or the like of the reception side (the reception ECU), the control unit 20 of the on-board device 2 determines whether the resolution of the reception ECU is rougher than the resolution of the transmission ECU. In this case, the control unit 20 of the on-board device 2 may also determine whether the resolution of the reception ECU is greater than or equal to the resolution of the transmission ECU, the maximum value of the reception ECU is less than or equal to the maximum value of the transmission ECU, and the minimum value of the reception ECU is greater than or equal to the minimum value of the transmission ECU (Reception Side Resolution≥Transmission Side Resolution) & (Reception Side Maximum Value≤Transmission Side Maximum Value) & (Reception Side Minimum Value≥Transmission Side Minimum Value).

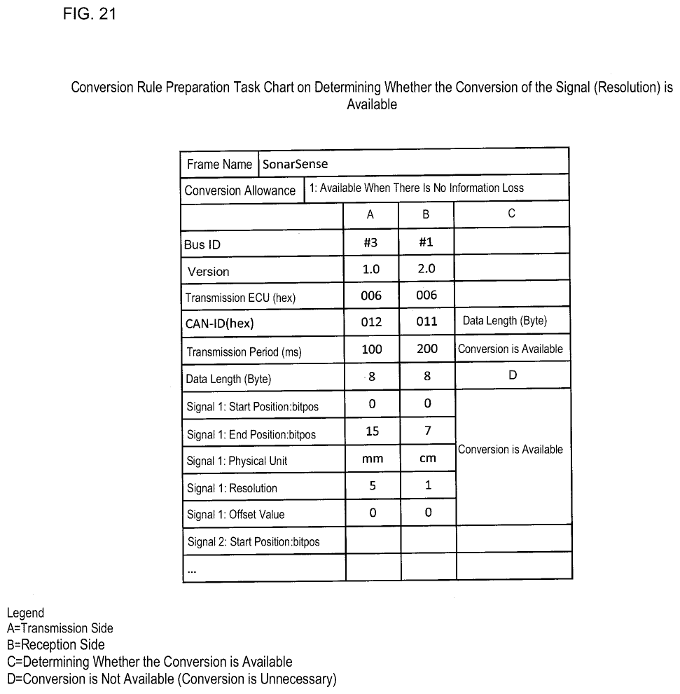

FIG. 21 is an explanatory diagram illustrating respects (the conversion rule preparation task chart) relevant to determining whether the conversion of the signal is available. In this embodiment, the values illustrated in the drawings are “Transmission Side Resolution: 5 mm<Reception Side Resolution: 10 mm”, “Transmission Side Minimum Value: 0 mm==Reception Side Minimum Value: 0 mm”, and “Transmission Side Maximum Value: 327,675 (65,535*5)>Reception Side Maximum Value: 2,550 mm”, in this case.

In a case where the resolution of the reception ECU is rougher than the resolution of the transmission ECU (D105: YES), the control unit 20 of the on-board device 2 sets that conversion is available, in the item of the resolution in the conversion rule preparation task chart (D106). In a case where the resolution or the like of the reception ECU is greater than the resolution or the like of the transmission ECU, the control unit 20 of the on-board device 2 sets that conversion is available, in the item of the resolution in the conversion rule preparation task chart. In this case, when the resolution of the reception ECU is greater than or equal to the resolution of the transmission ECU, the maximum value of the reception ECU is less than or equal to the maximum value of the transmission ECU, and the minimum value of the reception ECU is greater than or equal to the minimum value of the transmission ECU, the control unit 20 of the on-board device 2 may set that conversion is available, in the item of the resolution in the conversion rule preparation task chart. Since the transmission side resolution is finer than the resolution expected by the reception side, and there is no information loss, the control unit 20 of the on-board device 2 is capable of setting that the conversion is available.

In a case where the resolution of the reception ECU is not rougher than the resolution of the transmission ECU (D105: NO), the control unit 20 of the on-board device 2 determines whether the change allowance is consistently available (D1051). In a case where the resolution or the like of the reception ECU is not rougher than the resolution or the like of the transmission ECU, that is, in a case where the resolution or the like of the reception ECU is finer than the resolution or the like of the transmission ECU, the control unit 20 of the on-board device 2 determines whether the change allowance is consistently available. In this case, when the resolution of the reception ECU is finer than the resolution of the transmission ECU, the maximum value of the reception ECU is greater than the maximum value of the transmission ECU, or the minimum value of the reception ECU is less than the minimum value of the transmission ECU, the control unit 20 of the on-board device 2 may determine whether the change allowance is consistently available. Since there is a slight information loss in the resolution or the value range for the signal expected by the reception side, the control unit 20 of the on-board device 2 determines whether the change allowance is consistently available.

In a case where the change allowance is consistently available (D1051: YES), the control unit 20 of the on-board device 2 sets that conversion is available, in the item of the resolution in the conversion rule preparation task chart (D1052). In a case where the change allowance is consistently available, it is set that conversion is available (conversion OK), in the item of the resolution (the signal definition information) in the conversion rule preparation task chart. The control unit 20 of the on-board device 2 may return to the main routine (S4), after the processing of D104, D106, or D1052.

In a case where the change allowance is not consistently available (D1051: NO), the control unit 20 of the on-board device 2 sets that conversion is not available, in the item of the resolution in the conversion rule preparation task chart (D1053). The control unit 20 of the on-board device 2 aborts the processing of creating the conversion rule (D1054). In a case where the change allowance is not consistently available, it is set that conversion is not available by storing that the conversion is not available, in the control item of determining whether the conversion is available for the resolution (the signal definition information) in the conversion rule preparation task chart. In addition, the control unit 20 of the on-board device 2 aborts the processing of creating the conversion rule. That is, the control unit 20 of the on-board device 2 determines that conversion relay is not available, displays that the updated ECU is invalid, and outputs information for urging the version change or the like on the user (the operator of the vehicle C).

The control unit 20 of the on-board device 2 creates (completes) the conversion rule table by extracting and configuring items required for the conversion rule creation task chart from the conversion rule preparation task chart including the conversion rule created for each of the communication specification items. That is, in the updated ECU and the opponent ECU, as described above, in a case where the conversion of each of the communication specification items required and is not required for each of the frames with different definition versions, the control unit 20 of the on-board device 2 determines whether the conversion is available, and creates the conversion rule preparation task chart, on the basis of the determination result. In addition, the control unit 20 of the on-board device 2 creates the conversion rule table, on the basis of the created conversion rule creation task chart.

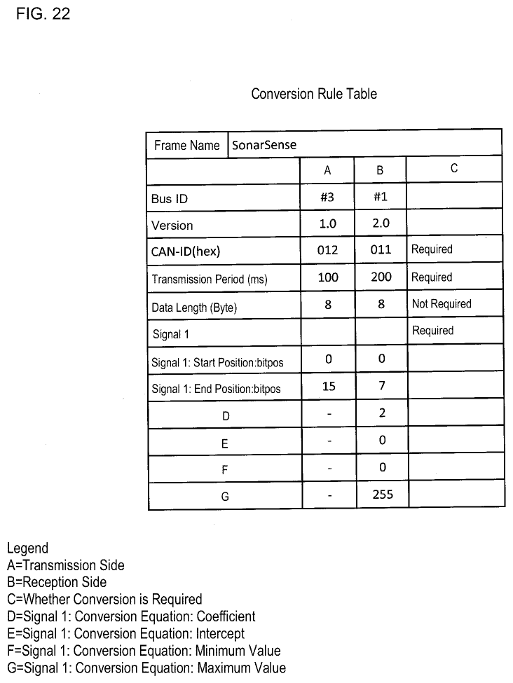

FIG. 22 is an explanatory diagram illustrating respects (the conversion rule table) relevant to the created conversion rule. The conversion rule table is created for each of the frames (for each of the frame names). The control item of the conversion rule table includes a transmission side, a reception side, and determining whether conversion is required, which are a horizontal item, and a bus ID, a version, CAN-ID, a transmission period, a data length, Signal 1, Signal 1: start position, Signal 1: end position, Signal 1: Conversion Equation: coefficient, Signal 1: Conversion Equation: intercept, Signal 1: Conversion Equation: minimum value, Signal 1: Conversion Equation: maximum value, which are a vertical item, and is configured in the shape of a matrix. Further, in addition to Signal 1, respects for other signals such as Signal 2 and Signal 3 may be included.

In the control item of the bus ID, the number of the communication line 41 such as a CAN bus to which the transmission ECU is connected and the number of the communication line 41 such as a CAN bus to which the reception ECU is connected are stored for the horizontal item of the transmission side and the reception side. In the control item of the version, the definition version of the frame of the transmission ECU and the definition version of the frame of the reception ECU are stored for the horizontal item of the transmission side and the reception side. In the control item of CAN-ID, the identifier (the message ID) of the frame transmitted by the transmission ECU and the identifier (the message ID) of the frame received by the reception ECU are stored for the horizontal item of the transmission side and the reception side. In the control item of the transmission period, the transmission period of the transmission ECU and the reception period of the reception ECU are stored for the horizontal item of the transmission side and the reception side. In the control item of the data length, the data length of the frame of the transmission ECU and the data length of the frame of the reception ECU are stored for the horizontal item of the transmission side and the reception side. In the control item of Signal 1, a null value is stored for the horizontal item of the transmission side and the reception side. In each of CAN-ID, the transmission period, the data length, and the vertical item (the communication specification item) of the Signal 1, that is, whether conversion is required, which is the horizontal item, whether the conversion is required (required or not required) is stored.

The control unit 20 of the on-board device 2 may be capable of aligning the unit of the signal definition and comparing the resolution when creating the conversion rule of each of the communication specification items relevant to Signal 1. In the control item of Signal 1: start position, a start bit number when Signal 1 of the frame of the transmission ECU is stored and a start bit number when Signal 1 of the frame of the reception ECU is stored are stored for the horizontal item of the transmission side and the reception side. In the control item of Signal 1: end position, an end bit number when Signal 1 of the frame of the transmission ECU is stored and an end bit number when Signal 1 of the frame of the reception ECU is stored are stored for the horizontal item of the transmission side and the reception side. In the control item of Signal 1: Conversion Equation: coefficient, the coefficient of Signal 1 of the frame of the transmission ECU and the coefficient of Signal 1 of the frame of the reception ECU are stored for the horizontal item of the transmission side and the reception side. In the control item of Signal 1: Conversion Equation: intercept, the intercept of Signal 1 of the frame of the transmission ECU and the intercept of Signal 1 of the frame of the reception ECU are stored for the horizontal item of the transmission side and the reception side. In the control item of Signal 1: Conversion Equation: minimum value, the minimum value of Signal 1 of the frame of the transmission ECU and the minimum value of Signal 1 of the frame of the reception ECU are stored for the horizontal item of the transmission side and the reception side. In the control item of Signal 1: Conversion Equation: maximum value, the maximum value of Signal 1 of the frame of the transmission ECU the maximum value of Signal 1 of the frame of the reception ECU are stored for the horizontal item of the transmission side and the reception side.

The control unit 20 of the on-board device 2 may be capable of aligning the unit of the signal definition and comparing the resolution when creating the conversion rule of each of the communication specification items relevant to Signal 1. That is, the control unit 20 of the on-board device 2, in the unit of the transmission side and the reception side, may extract the smaller unit (extracts “mm” in a case where there are “cm” and “mm”), and may convert the value of resolution of both of the transmission side and the reception side into the smaller unit for unification. The control unit 20 of the on-board device 2 may calculate the coefficient by dividing the transmission side physical resolution by the reception side physical resolution “Coefficient=Transmission Side Physical Resolution/Reception Side Physical Resolution”. The control unit 20 of the on-board device 2 may calculate the intercept by subtracting the reception side offset value from a value obtained by multiplying the transmission side offset value by the coefficient “Intercept=Transmission Side Offset Value×Coefficient−Reception Side Offset Value”. The control unit 20 of the on-board device 2 may calculate the maximum value and the minimum value (reception side) of the signal from the number of definition bits (for example, in the case of 8 bits, Minimum Value: 0, Maximum Value: 255 (=2\hat{ }8−1)) of the signal. In this case, the reception side signal and the transmission side signal may be indicated by a calculus equation “Reception Side Signal=Transmission Side Signal×Coefficient+Intercept”, and when the reception side minimum value is greater than the transmission side signal “if Reception Side Minimum Value>Transmission Side Signal”, the reception side signal may correspond to the reception side minimum value “Reception Side Signal=Reception Side Minimum Value”, and when the reception side maximum value is less than the transmission side signal “if Reception Side Maximum Value<Transmission Side Signal”, the reception side signal may correspond to the reception side maximum value “Reception Side Signal=Reception Side Maximum Value”.

In each of the transmission side and the reception side, the physical value is indicated by a calculus equation “Physical Value=(Value of Signal+Offset Value)×Resolution”, and the physical value is not changed between the transmission side and the reception side. Accordingly, in the transmission ECU (transmission) and the reception ECU (reception), each of the signal values is indicated by a calculus equation “(Signal Value (Transmission)+Offset Value (Transmission))×Resolution (Transmission)=(Signal Value (Reception)+Offset Value (Reception))×Resolution (Reception)”. The calculus equation is indicated by “(Signal Value (Transmission)+Offset Value (Transmission))×(Resolution (Transmission)/Resolution (Reception))=(Signal Value (Reception)+Offset Value (Reception))”, is indicated by “(Signal Value (Transmission)+Offset Value (Transmission))×Coefficient=(Signal Value (Reception)+Offset Value (Reception))”, is indicated by “Signal Value (Reception)=(Signal Value (Transmission)+Offset Value (Transmission))×Coefficient−Offset Value (Reception)”, and is indicated by “Signal Value (Reception)=Signal Value (Transmission)×Coefficient+{Offset Value (Transmission)×Coefficient−Offset Value (Reception)}”. By defining the conversion rule as described above, the control unit 20 of the on-board device 2 is capable of performing conversion, in consideration of the physical unit of the signal.

The control unit 20 of the on-board device 2 stores the created conversion rule in the storage unit 23. In this embodiment, the on-board device 2 acquires various types of information from the on-board ECU 3, but the disclosure is not limited thereto. The on-board device 2 may acquire the entire information required for this processing or a part of the information from the external server SV1 via the vehicle exterior communication device 1 and the vehicle exterior network N.

The control unit 20 of the on-board device 2 starts relay processing by using the created conversion rule (S5). The control unit 20 of the on-board device 2 in which the conversion rule of each of the frames (for each of the frame names) is stored in the storage unit 23 of the on-board device 2 performs the relay processing on the frames with different definition versions in the transmission ECU and the reception ECU, with reference to the conversion rule stored in the storage unit 23. The control unit 20 of the on-board device 2 extracts the identifier (CAN-ID) or the frame name included in the received frame, and performs conversion processing on the frame, with reference to the conversion rule corresponding to the extracted frame name.

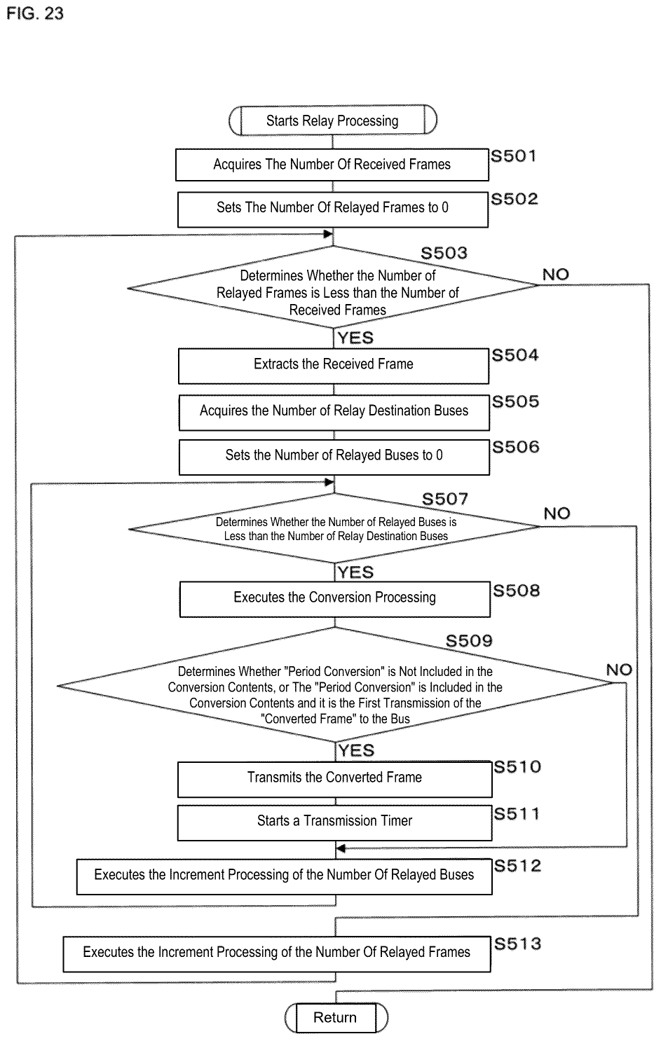

FIG. 23 is a flowchart illustrating the processing (the relay processing) of the control unit 20 of the on-board device 2. The control unit 20 of the on-board device 2 performs the following processing when starting the relay processing by using the conversion rule.

The control unit 20 of the on-board device 2 acquires the number of received frames (S501). In a case where, for example, the communication protocol of CAN is used, the control unit 20 of the on-board device 2 acquires the number of received CAN frames (the number of CAN frames received), with reference to a register of a CAN reception port that is the vehicle interior communication unit 22.

The control unit 20 of the on-board device 2 sets the number of relayed frames to 0 (S502). The control unit 20 of the on-board device 2 sets the number of relayed frames to 0 (stores the number in the storage unit 23) to initialize the number of relayed frames.

The control unit 20 of the on-board device 2 determines whether the number of relayed frames is less than the number of received frames (S503). The control unit 20 of the on-board device 2 determines whether the number of relayed frames is less than the number of received frames “Number of Relayed Frames<Number of Received CAN Frames”.

In a case where the number of relayed frames is less than the number of received frames (S503: YES), the control unit 20 of the on-board device 2 extracts the received frame (S504). In a case where the number of relayed frames is less than the number of received frames, the control unit 20 of the on-board device 2 extracts a CAN reception frame from the CAN reception port to extract the received frame.

The control unit 20 of the on-board device 2 acquires the number of relay destination buses (S505). A routing map used when performing the relay processing is stored in the storage unit 23 of the on-board device 2, which functions as a relay device. Information relevant to the relay destination bus (the communication the line 41) for each of the frames (for each of the frame names) is included in the routing map. The control unit 20 of the on-board device 2 acquires the number of relay destination buses and a relay destination bus ID list, with reference to the routing map stored in the storage unit 23.

The control unit 20 of the on-board device 2 sets the number of relayed buses to 0 (S506). The control unit 20 of the on-board device 2 sets the number of relayed buses to 0 (stores the number in the storage unit 23) to initialize the number of relayed buses.

The control unit 20 of the on-board device 2 determines whether the number of relayed buses is less than the number of relay destination buses (S507). The control unit 20 of the on-board device 2 determines whether the number of relayed buses is less than the number of relay destination buses “Number of Relayed Buses”<“Number of Relay Destination Buses”.

In a case where the number of relayed buses is less than the number of relay destination buses (S507: YES), the control unit 20 of the on-board device 2 executes the conversion processing by using the conversion rule (S508). In a case where the number of relayed buses is less than the number of relay destination buses, the control unit 20 of the on-board device 2 executes the conversion processing such as CAN-ID conversion, data length conversion, or signal conversion, as necessary (on the communication specification item in the conversion rule table, in which conversion is required), with reference to the conversion rule table using CAN-ID (the identifier of the frame) as a key.

That is, the control unit 20 of the on-board device 2 sets CAN-ID of the reception side, in the CAN-ID conversion. The control unit 20 of the on-board device 2 sets the data length of the reception side, in the data length conversion. The control unit 20 of the on-board device 2 sets the reception side signal as a value indicated by a calculus equation “Reception Side Signal=Transmission Side Signal×Coefficient+Intercept”, in the signal conversion, and in this case, when the reception side minimum value is greater than the transmission side signal “if Reception Side Minimum Value>Transmission Side Signal”, the reception side signal may be set to the reception side minimum value “Reception Side Signal=Reception Side Minimum Value”, and when the reception side maximum value is less than the transmission side signal “if Reception Side Maximum Value<Transmission Side Signal”, the reception side signal may be set to the reception side maximum value “Reception Side Signal=Reception Side Maximum Value”.

The control unit 20 of the on-board device 2 determines whether “period conversion” is not included in the conversion contents, or the “period conversion” is included in the conversion contents and it is the first transmission of the “converted frame” to the bus (S509). In a case where the “period conversion” is not included in the conversion contents, or the “period conversion” is included in the conversion contents and it is the first transmission of the “converted frame” to the bus (S509: YES), the control unit 20 of the on-board device 2 transmits the converted frame (S510). The number of relayed frames is increased by one (+1) each time when the frame is relayed, by increment processing described later. The control unit 20 of the on-board device 2, for example, may determine whether it is the first time that the converted frame is relayed, on the basis of the number of relayed frames.

The control unit 20 of the on-board device 2 starts a transmission timer (S511). In a case where the transmission period of the communication specification item is required to be converted (whether the conversion is required), the control unit 20 of the on-board device 2 may perform processing relevant to the transmission timer. In this case, the control unit 20 of the on-board device 2 may transmit the converted frame to the transmission side bus, as reception side period timer expiration interrupt, and may start the transmission timer (the reception side period).

After the processing of S511, or in a case where the “period conversion” is not included in the conversion contents, or the “period conversion” is included in the conversion contents and it is not the first transmission of the “converted frame” to the bus (S509: NO), the control unit 20 of the on-board device 2 executes the increment processing of the number of relayed buses (S512). The control unit 20 of the on-board device 2 executes the increment processing (“Number of Relayed Buses”←“Number of Relayed Buses”+1) by increasing the number of relayed buses by one (+1), and performs loop processing to execute again the processing from S507.

In a case where the number of relayed buses is not less than the number of relay destination buses (S507: NO), the control unit 20 of the on-board device 2 executes the increment processing of the number of relayed frames (S513). The control unit 20 of the on-board device 2 executes the increment processing (“Number of Relayed Frames”←“Number of Relayed Frames”+1) by increasing the number of relayed frames by one (+1), and performs loop processing to execute again the processing from S503.

In a case where the number of relayed frames is not less than the number of received frames (S503: NO), the control unit 20 of the on-board device 2 ends this processing. In a case where the number of relayed frames is not less than the number of received frames, that is, in a case where the number of relayed frames is greater than or equal to the number of received frames (in a case where the number of relayed frames reaches the number of received frames), the control unit 20 of the on-board device 2 ends this processing.

The embodiments disclosed herein should be considered as illustrative in all respects and not restrictive. The scope of the disclosure is indicated by the claims, but not the meaning described above, and is intended to include the meaning equivalent to the claims and all modifications within the scope.

A plurality of claims set forth in the claims can be combined with each other in any and all combinations, regardless of the format of reference. A multiple dependent claim dependent on a plurality of claims may be set forth in the claims. A multiple dependent claim dependent on a multiple dependent claim may be set forth. Even in a case where the multiple dependent claim dependent on the multiple dependent claim is not set forth, this does not limit the description of the multiple dependent claim dependent on the multiple dependent claim.

What is claimed is:

1. An on-board device connected to a plurality of on-board ECUs mounted on a vehicle such that communication is available, the device comprising:
a control unit processing a frame transmitted/received between the on-board ECUs,
wherein the control unit
acquires information relevant to software executed in each of the plurality of on-board ECUs,
specifies the frame transmitted/received when the software is executed, on the basis of the acquired information relevant to software,
specifies a transmission ECU transmitting the specified frame and a reception ECU receiving the specified frame,
acquires definition information of the frame of the transmission ECU,
acquires definition information of the frame of the reception ECU,
creates a conversion rule of the frame, on the basis of the definition information of the frame of the transmission ECU and the definition information of the frame of the reception ECU,
converts the frame from the transmission ECU by using the created conversion rule of the frame, and
outputs the converted frame to the reception ECU.

2. The on-board device according to claim 1,
wherein the information relevant to software includes a version of the software, and
the control unit
specifies an updated ECU in which the software is updated, on the basis of the version of the software, in the plurality of on-board ECUs, and
specifies the frame transmitted/received when the software implemented on the specified updated ECU is executed.

3. The on-board device according to claim 2,
wherein the information relevant to software includes the version of the frame transmitted/received when the software is executed, and
the control unit
creates the conversion rule of the frame when the version of the frame of the transmission ECU is different from the version of the frame of the reception ECU.

4. The on-board device according to claim 3,
wherein the definition information of the frame includes a plurality of communication specification items, and
the control unit
determines whether there is a variation in each of the communication specification items included in the definition information of the frames of the transmission ECU and the reception ECU, and
creates the conversion rule in accordance with the communication specification item with a variation.

5. The on-board device according to claim 4,
wherein the communication specification item includes an identifier of the frame, and
the control unit creates the conversion rule by including that the identifier of the frame of the transmission ECU is converted into the identifier of the frame of the reception ECU when the identifiers of the frames are different in the frames of the transmission ECU and the reception ECU.

6. The on-board device according to claim 4,
wherein the communication specification item includes a period of the frame, and
the control unit creates the conversion rule by including that the period of the frame of the transmission ECU is converted into the period of the frame of the reception ECU when the period of the frame of the transmission ECU is shorter than the period of the frame of the reception ECU or when the reception ECU allows a variation in the period.

7. The on-board device according to claim 4,
wherein the communication specification item includes a data length of the frame, and
the control unit creates the conversion rule by including that the data length of the frame of the transmission ECU is converted into the data length of the frame of the reception ECU when the data length of the frame of the transmission ECU is longer than the data length of the frame of the reception ECU or when the reception ECU allows a variation in the data length.

8. The on-board device according to claim 4,
wherein the communication specification item includes resolution of data included in the frame, and
the control unit creates the conversion rule by including that the resolution of the frame of the transmission ECU is converted into the resolution of the frame of the reception ECU when the resolution of the frame of the transmission ECU is finer than the resolution of the frame of the reception ECU or when the reception ECU allows a variation in the resolution.

9. The on-board device according to claim 4,
wherein the control unit
extracts the communication specification item with a variation between the transmission ECU and the reception ECU, in the plurality of communication specification items included in the definition information of the frame,
determines whether conversion is available in the communication specification item with a variation, and
aborts processing of creating the conversion rule when conversion is not available in the communication specification item.

10. A program causing a computer that is connected to a plurality of on-board ECUs mounted on a vehicle such that communication is available and performs processing relevant to a frame transmitted/received between the on-board ECUs to execute processing of:
acquiring information relevant to software executed in each of the plurality of on-board ECUs;
specifying the frame transmitted/received when the software is executed, on the basis of the acquired information relevant to software;
specifying a transmission ECU transmitting the specified frame and a reception ECU receiving the specified frame;
acquiring definition information of the frame of the transmission ECU;
acquiring definition information of the frame of the reception ECU;
creating a conversion rule of the frame, on the basis of the definition information of the frame of the transmission ECU and the definition information of the frame of the reception ECU;
converting the frame from the transmission ECU by using the created conversion rule of the frame; and
outputting the converted frame to the reception ECU.

11. An information processing method causing a computer that is connected to a plurality of on-board ECUs mounted on a vehicle such that communication is available and performs processing relevant to a frame transmitted/received between the on-board ECUs to execute processing of:
acquiring information relevant to software executed in each of the plurality of on-board ECUs;
specifying the frame transmitted/received when the software is executed, on the basis of the acquired information relevant to software;
specifying a transmission ECU transmitting the specified frame and a reception ECU receiving the specified frame;
acquiring definition information of the frame of the transmission ECU;
acquiring definition information of the frame of the reception ECU;
creating a conversion rule of the frame, on the basis of the definition information of the frame of the transmission ECU and the definition information of the frame of the reception ECU;
converting the frame from the transmission ECU by using the created conversion rule of the frame; and
outputting the converted frame to the reception ECU.
